(19) United States
(12) Patent Application Publication
(10) Pub. No.: US 2023/0100315 A1
(43) Pub. Date: Mar. 30, 2023

(54) Pattern Identification for Incident Prediction and Resolution

(71) Applicant: CenturyLink Intellectual Property LLC, Broomfield, CO (US)

(72) Inventors: Santhosh Plakkatt, Bangalore (IN); Swati Vishwakarma, Bangalore (IN)

(21) Appl. No.: 17/537,089

(22) Filed: Nov. 29, 2021

Related U.S. Application Data
(60) Provisional application No. 63/249,182, filed on Sep. 28, 2021.

(51) Int. Cl. G06Q 10/06

(52) U.S. Cl. CPC G06Q 10/06395; G06Q 10/06393

(57) ABSTRACT

Novel tools and techniques are provided for implementing pattern identification for incident prediction and resolution. In various embodiments, a computing system may receive a set of data associated with a service provided by a service provider, the set of data including current data and historical data associated with the service. The computing system may analyze the historical data to generate baselining data associated with the service based on a prediction model, may analyze the current data compared with the baselining data to identify one or more issues associated with the service, and may analyze the identified one or more issues to perform predictions and to determine which issues require redressal and which issues can be left without redressal, based on the predictions. The computing system may generate and send one or more recommendations regarding which issues require redressal and which issues can be left without redressal.

### CROSS-REFERENCES TO RELATED APPLICATIONS

This application claims priority to U.S. Patent Application Ser. No. 63/249,182 (the “'182 Application”), filed Sep. 28, 2021, by Santhosh Plakkatt et al. (attorney docket no. 1649-US-P1), entitled, “Pattern Identification for Incident Prediction and Resolution,” the disclosure of which is incorporated herein by reference in its entirety for all purposes.

The respective disclosures of these applications/patents (which this document refers to collectively as the “Related Applications”) are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing incident prediction and resolution, and, more particularly, to methods, systems, and apparatuses for implementing pattern identification for incident prediction and resolution.

### BACKGROUND

In conventional service management systems and techniques, the focus is on address each and every problem or issue that is identified or encountered (in some cases, in the order that such problems or issues are discovered). However, such approaches lead to inefficiencies in terms of human and physical resource use, as a vast proportion of problems or issues do not need to be worked on or do not need to be immediately worked on, resulting in wasted time and effort.

Hence, there is a need for more robust and scalable solutions for implementing incident prediction and resolution, and, more particularly, to methods, systems, and apparatuses for implementing pattern identification for incident prediction and resolution.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic diagram illustrating a system for implementing pattern identification for incident prediction and resolution, in accordance with various embodiments.

FIG. 2 is a schematic block flow diagram illustrating a non-limiting example method of pattern identification, baselining, prediction, and problem management that may be implemented during pattern identification for incident prediction and resolution, in accordance with various embodiments.

FIG. 3A is a schematic block flow diagram illustrating another non-limiting example method of pattern identification, baselining, prediction, and problem management that may be implemented during pattern identification for incident prediction and resolution, in accordance with various embodiments.

FIGS. 3B-3M are schematic diagrams illustrating a non-limiting example service management use case that depicts implementation of pattern identification, baselining, prediction, and problem management during pattern identification for incident prediction and resolution, in accordance with various embodiments.

FIGS. 3N-3Y are schematic diagrams illustrating a non-limiting example entertainment content ratings use case that depicts implementation of pattern identification, baselining, prediction, and problem management during pattern identification for incident prediction and resolution, in accordance with various embodiments.

FIGS. 4A-4E are flow diagrams illustrating a method for implementing pattern identification for incident prediction and resolution, in accordance with various embodiments.

FIG. 5 is a block diagram illustrating an exemplary computer or system hardware architecture, in accordance with various embodiments.

FIG. 6 is a block diagram illustrating a networked system of computers, computing systems, or system hardware architecture, which can be used in accordance with various embodiments.

### DETAILED DESCRIPTION OF CERTAIN EMBODIMENTS

Overview

Various embodiments provide tools and techniques for implementing incident prediction and resolution, and, more particularly, to methods, systems, and apparatuses for implementing pattern identification for incident prediction and resolution.

In various embodiments, a computing system may receive a first set of data associated with a service provided by a service provider. In some cases, the first set of data may include, but is not limited to, current data associated with the service and historical data associated with the service, and/or the like. The computing system may analyze the historical data to generate baselining data associated with the service based on a prediction model. The computing system may analyze the current data compared with the baselining data to identify one or more issues associated with the service. The computing system may analyze the identified one or more issues to perform one or more predictions and to determine which of the identified one or more issues require redressal and which of the identified one or more issues can be left without redressal (i.e., issues that may be avoided, or the like), based on the one or more predictions. The computing system may generate and send one or more recommendations regarding which of the identified one or more issues require redressal and which of the identified one or more issues can be left without redressal.

In some cases, the first set of data may include service management input data including, but not limited to, at least one of service management input data, service incident data, warning data, event log data, error data, alert data, human resources input data, or service team input data, and/or the like.

According to some embodiments, the computing system may perform data preprocessing, which may include, without limitation: performing data classification on the first set of data, by providing data labelling to the first set of data based at least in part on type of data; performing data cleaning on the first set of data based at least in part on the data classification to produce second set of data, the second set of data including, but not limited to, non-redundant, non-blank, non-formatted data without punctuations, whitespaces, stop words, and non-conforming data structures, or the like; performing data distribution on the second set of data to produce balanced data based at least in part on data labelling and data classification; performing feature extraction on the balanced data to identify at least one of key features or attributes of data among the balanced data; and performing vectorization on the at least one of the key features or the attributes of data among the balanced data, by assigning probabilities to similar features to conform more closely to the data labelling; and/or the like. In some cases, generating baselining data may be based at least in part on the vectorization performed on the at least one of the key features or the attributes of data among the balanced data, or the like. In some instances, the prediction model may be an AI model, and the computing system may update the prediction model to improve baselining data generation, based at least in part on the vectorization performed on the at least one of the key features or the attributes of data among the balanced data.

In some embodiments, the computing system performing the one or more predictions may include, but are not limited to, at least one of: performing category prediction to classify the identified one or more issues into one or more categories; performing problem prediction to identify one or more problem areas for each of the identified one or more issues; calculating prediction likelihood to determine at least one of likelihood of category prediction being correct or likelihood of problem prediction being correct; or performing anomaly detection and management to identify one or more anomalies among at least one of the identified one or more issues, the historical data associated with the service, or the current data associated with the service, and/or the like; and/or the like. In some cases, determining which of the identified one or more issues require redressal and which of the identified one or more issues can be left without redressal may comprise determining which of the identified one or more issues require redressal and which of the identified one or more issues can be left without redressal based at least in part on at least one of the classified one or more categories, the determined one or more problem areas, the determined likelihood of category prediction being correct, the determined likelihood of problem prediction being correct, or the identified one or more anomalies, and/or the like. In some instances, performing problem prediction may comprise performing active prediction to identify at least one of one or more future incidents, one or more future problems, a relation matrix among at least one of the one or more future problems or the identified one or more problem areas, one or more potential incident trends, one or more potential problem trends, or one or more visualization data adapted to service management, and/or the like. In some cases, the computing system may generate at least one of a potential problem signature or one or more crisis patterns, based at least in part on the active prediction and based at least in part on automated task creation and resolution.

According to some embodiments, determining which of the identified one or more issues require redressal and which of the identified one or more issues can be left without redressal may alternatively or additionally comprise determining which of the identified one or more issues require redressal and which of the identified one or more issues can be left without redressal, by predicting probabilities for one or more future outcomes resulting from at least one of addressing each of the identified one or more issues or leaving unaddressed each of the identified one or more issues, and generating weighted values for each of the recommendations based at least in part on the predicted probabilities for the one or more future outcomes and based at least in part on resource allocation determination for addressing each of the identified one or more issues.

In some embodiments, the computing system may further perform at least one of: generating and sending one or more first instructions to one or more automated nodes among a plurality of nodes associated with, owned by, or operated by the service provider, the one or more first instructions causing the one or more automated nodes to autonomously address the identified one or more issues requiring redressal based on the one or more recommendations; or generating and sending one or more first service tickets to one or more service technicians with instructions and information for addressing the identified one or more issues requiring redressal based on the one or more recommendations; and/or the like.

According to some embodiments, analyzing the historical data and analyzing the current data may be part of a data preprocessing portion, and the computing system may perform a false positive check by using a feedback loop to feed back a selected set of data from the one or more recommendations as input into the data preprocessing portion, where generating the baselining data and identifying the one or more issues may be performed based on the selected set of data. In some instances, the selected set of data may comprise a random recommendation among a first predetermined number of recommendations, the random recommendation being based on a random pattern that is sequentially changed to ensure that the selection is not based on any set pattern. In some cases, a prediction generation logic used to perform problem prediction may be validated against control data for every second predetermined number of recommendations.

The various embodiments provide for systems and methods that implement pattern identification for incident prediction and resolution that provide optimized service management prediction, baselining, and redressal or avoidance functionality for service management applications (or optimized success/failure prediction, baselining, and redressal or avoidance functionality for non-service applications), and/or the like, while taking into account predicted future outcomes or consequences as well as taking into account resource management (especially for limited resources that may not be sufficient for addressing each and every issue that has been identified, particularly, within limited time windows, or the like). For example, by identifying issues that can be avoided (i.e., left without being addressed or redressed), the limited resources may be reserved for issues that are deemed to be more suitable for immediate redressal. In some cases, the issues recommended for avoidance may be determined, based on predicted future outcomes or consequences, to be potentially self-correcting. Alternatively, the issues recommended for avoidance may be determined, based on predicted future outcomes or consequences, to affect only a very small number of people or regions (or may have a lesser impact) compared with some issues recommended for redressal that may affect a much larger number of people or regions (or may have a greater impact).

These and other aspects of the system and method for implementing pattern identification for incident prediction and resolution are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Various embodiments described herein, while embodying (in some cases) software products, computer-performed methods, and/or computer systems, represent tangible, concrete improvements to existing technological areas, including, without limitation, incident prediction technology, incident resolution technology, incident prediction and resolution technology, pattern identification technology, service management technology, workflow management technology, issue redressal technology, success/failure prediction technology, and/or the like. In other aspects, certain embodiments, can improve the functioning of user equipment or systems themselves (e.g., incident prediction systems, incident resolution systems, incident prediction and resolution systems, pattern identification systems, service management systems, workflow management systems, issue redressal systems, success/failure prediction systems, etc.), for example, by receiving, using a computing system, a first set of data associated with a service provided by a service provider, wherein the first set of data comprises current data associated with the service and historical data associated with the service; analyzing, using the computing system, the historical data to generate baselining data associated with the service based on a prediction model; analyzing, using the computing system, the current data compared with the baselining data to identify one or more issues associated with the service; analyzing, using the computing system, the identified one or more issues to perform one or more predictions and to determine which of the identified one or more issues require redressal and which of the identified one or more issues can be left without redressal, based on the one or more predictions; and generating and sending, using the computing system, one or more recommendations regarding which of the identified one or more issues require redressal and which of the identified one or more issues can be left without redressal; and/or the like.

In particular, to the extent any abstract concepts are present in the various embodiments, those concepts can be implemented as described herein by devices, software, systems, and methods that involve specific novel functionality (e.g., steps or operations), such as, analyzing, using the computing system, the historical data to generate baselining data associated with the service based on a prediction model; analyzing, using the computing system, the current data compared with the baselining data to identify one or more issues associated with the service; analyzing, using the computing system, the identified one or more issues to perform one or more predictions and to determine which of the identified one or more issues require redressal and which of the identified one or more issues can be left without redressal, based on the one or more predictions; and generating and sending, using the computing system, one or more recommendations regarding which of the identified one or more issues require redressal and which of the identified one or more issues can be left without redressal; and/or the like, to name a few examples, that extend beyond mere conventional computer processing operations. These functionalities can produce tangible results outside of the implementing computer system, including, merely by way of example, optimized service management prediction, baselining, and redressal or avoidance functionality for service management applications (or optimized success/failure prediction, baselining, and redressal or avoidance functionality for non-service applications), and/or the like, that take into account predicted future outcomes or consequences as well as taking into account resource management, at least some of which may be observed or measured by content consumers, content providers, and/or service providers.

In an aspect, a method may comprise receiving, using a computing system, a first set of data associated with a service provided by a service provider, wherein the first set of data comprises current data associated with the service and historical data associated with the service; analyzing, using the computing system, the historical data to generate baselining data associated with the service based on a prediction model; analyzing, using the computing system, the current data compared with the baselining data to identify one or more issues associated with the service; analyzing, using the computing system, the identified one or more issues to perform one or more predictions and to determine which of the identified one or more issues require redressal and which of the identified one or more issues can be left without redressal, based on the one or more predictions; and generating and sending, using the computing system, one or more recommendations regarding which of the identified one or more issues require redressal and which of the identified one or more issues can be left without redressal.

In some embodiments, the computing system may comprise at least one of a service management computing system, an artificial intelligence (“AI”) system, a machine learning system, a deep learning system, a server computer over a network, a cloud computing system, or a distributed computing system, and/or the like. In some cases, the first set of data may comprise service management input data comprising at least one of service management input data, service incident data, warning data, event log data, error data, alert data, human resources input data, or service team input data, and/or the like.

According to some embodiments, the method may further comprise performing data preprocessing comprising: performing, using the computing system, data classification on the first set of data, by providing data labelling to the first set of data based at least in part on type of data; performing, using the computing system, data cleaning on the first set of data based at least in part on the data classification to produce second set of data, the second set of data comprising non-redundant, non-blank, non-formatted data without punctuations, whitespaces, stop words, and non-conforming data structures; performing, using the computing system, data distribution on the second set of data to produce balanced data based at least in part on data labelling and data classification; performing, using the computing system, feature extraction on the balanced data to identify at least one of key features or attributes of data among the balanced data; and performing, using the computing system, vectorization on the at least one of the key features or the attributes of data among the balanced data, by assigning probabilities to similar features to conform more closely to the data labelling. In some cases, generating baselining data may be based at least in part on the vectorization performed on the at least one of the key features or the attributes of data among the balanced data, or the like. In some instances, the prediction model may be an artificial intelligence (“AI”) model, and the method may further comprise updating, using the computing system, the prediction model to improve baselining data generation, based at least in part on the vectorization performed on the at least one of the key features or the attributes of data among the balanced data.

In some embodiments, performing the one or more predictions may comprise at least one of: performing, using the computing system, category prediction to classify the identified one or more issues into one or more categories; performing, using the computing system, problem prediction to identify one or more problem areas for each of the identified one or more issues; calculating, using the computing system, prediction likelihood to determine at least one of likelihood of category prediction being correct or likelihood of problem prediction being correct; or performing, using the computing system, anomaly detection and management to identify one or more anomalies among at least one of the identified one or more issues, the historical data associated with the service, or the current data associated with the service; and/or the like. In some cases, determining which of the identified one or more issues require redressal and which of the identified one or more issues can be left without redressal may comprise determining which of the identified one or more issues require redressal and which of the identified one or more issues can be left without redressal based at least in part on at least one of the classified one or more categories, the determined one or more problem areas, the determined likelihood of category prediction being correct, the determined likelihood of problem prediction being correct, or the identified one or more anomalies, and/or the like. In some instances, performing problem prediction may comprise performing active prediction to identify at least one of one or more future incidents, one or more future problems, a relation matrix among at least one of the one or more future problems or the identified one or more problem areas, one or more potential incident trends, one or more potential problem trends, or one or more visualization data adapted to service management, and/or the like. In some cases, the method may further comprise generating, using the computing system, at least one of a potential problem signature or one or more crisis patterns, based at least in part on the active prediction and based at least in part on automated task creation and resolution.

According to some embodiments, determining which of the identified one or more issues require redressal and which of the identified one or more issues can be left without redressal may comprise determining which of the identified one or more issues require redressal and which of the identified one or more issues can be left without redressal, by predicting probabilities for one or more future outcomes resulting from at least one of addressing each of the identified one or more issues or leaving unaddressed each of the identified one or more issues, and generating weighted values for each of the recommendations based at least in part on the predicted probabilities for the one or more future outcomes and based at least in part on resource allocation determination for addressing each of the identified one or more issues.

In some embodiments, the method may further comprise at least one of: generating and sending, using the computing system, one or more first instructions to one or more automated nodes among a plurality of nodes associated with, owned by, or operated by the service provider, the one or more first instructions causing the one or more automated nodes to autonomously address the identified one or more issues requiring redressal based on the one or more recommendations; or generating and sending, using the computing system, one or more first service tickets to one or more service technicians with instructions and information for addressing the identified one or more issues requiring redressal based on the one or more recommendations; and/or the like.

According to some embodiments, analyzing the historical data and analyzing the current data may be part of a data preprocessing portion, and the method may further comprise performing, using the computing system, a false positive check by using a feedback loop to feed back a selected set of data from the one or more recommendations as input into the data preprocessing portion, and generating the baselining data and identifying the one or more issues may be performed based on the selected set of data. In some instances, the selected set of data may comprise a random recommendation among a first predetermined number of recommendations, the random recommendation being based on a random pattern that is sequentially changed to ensure that the selection is not based on any set pattern. In some cases, a prediction generation logic used to perform problem prediction may be validated against control data for every second predetermined number of recommendations.

In another aspect, a system might comprise a computing system, which might comprise at least one first processor and a first non-transitory computer readable medium communicatively coupled to the at least one first processor. The first non-transitory computer readable medium might have stored thereon computer software comprising a first set of instructions that, when executed by the at least one first processor, causes the computing system to: receive a first set of data associated with a service provided by a service provider, wherein the first set of data comprises current data associated with the service and historical data associated with the service; analyze the historical data to generate baselining data associated with the service based on a prediction model; analyze the current data compared with the baselining data to identify one or more issues associated with the service; analyze the identified one or more issues to perform one or more predictions and to determine which of the identified one or more issues require redressal and which of the identified one or more issues can be left without redressal, based on the one or more predictions; and generate and send one or more recommendations regarding which of the identified one or more issues require redressal and which of the identified one or more issues can be left without redressal.

In some embodiments, the computing system may comprise at least one of a service management computing system, an artificial intelligence (“AI”) system, a machine learning system, a deep learning system, a server computer over a network, a cloud computing system, or a distributed computing system, and/or the like. In some instances, the first set of data may comprise service management input data comprising at least one of service management input data, service incident data, warning data, event log data, error data, alert data, human resources input data, or service team input data, and/or the like.

According to some embodiments, the first set of instructions, when executed by the at least one first processor, may further cause the computing system to perform data preprocessing comprising: performing data classification on the first set of data, by providing data labelling to the first set of data based at least in part on type of data; performing data cleaning on the first set of data based at least in part on the data classification to produce second set of data, the second set of data comprising non-redundant, non-blank, non-formatted data without punctuations, whitespaces, stop words, and non-conforming data structures; performing data distribution on the second set of data to produce balanced data based at least in part on data labelling and data classification; performing feature extraction on the balanced data to identify at least one of key features or attributes of data among the balanced data; and performing vectorization on the at least one of the key features or the attributes of data among the balanced data, by assigning probabilities to similar features to conform more closely to the data labelling. In some cases, generating baselining data may be based at least in part on the vectorization performed on the at least one of the key features or the attributes of data among the balanced data. In some instances, the prediction model may be an artificial intelligence (“AI”) model, and the first set of instructions, when executed by the at least one first processor, may further cause the computing system to update the prediction model to improve baselining data generation, based at least in part on the vectorization performed on the at least one of the key features or the attributes of data among the balanced data.

In some embodiments, determining which of the identified one or more issues require redressal and which of the identified one or more issues can be left without redressal may comprise determining which of the identified one or more issues require redressal and which of the identified one or more issues can be left without redressal, by predicting probabilities for one or more future outcomes resulting from at least one of addressing each of the identified one or more issues or leaving unaddressed each of the identified one or more issues, and generating weighted values for each of the recommendations based at least in part on the predicted probabilities for the one or more future outcomes and based at least in part on resource allocation determination for addressing each of the identified one or more issues.

According to some embodiments, the first set of instructions, when executed by the at least one first processor, may further cause the computing system to perform at least one of: generating and sending one or more first instructions to one or more automated nodes among a plurality of nodes associated with, owned by, or operated by the service provider, the one or more first instructions causing the one or more automated nodes to autonomously address the identified one or more issues requiring redressal based on the one or more recommendations; or generating and sending one or more first service tickets to one or more service technicians with instructions and information for addressing the identified one or more issues requiring redressal based on the one or more recommendations; and/or the like. In some cases, analyzing the historical data and analyzing the current data may be part of a data preprocessing portion, and the first set of instructions, when executed by the at least one first processor, may further cause the computing system to perform a false positive check by using a feedback loop to feed back a selected set of data from the one or more recommendations as input into the data preprocessing portion, and generating the baselining data and identifying the one or more issues may be performed based on the selected set of data.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### Specific Exemplary Embodiments

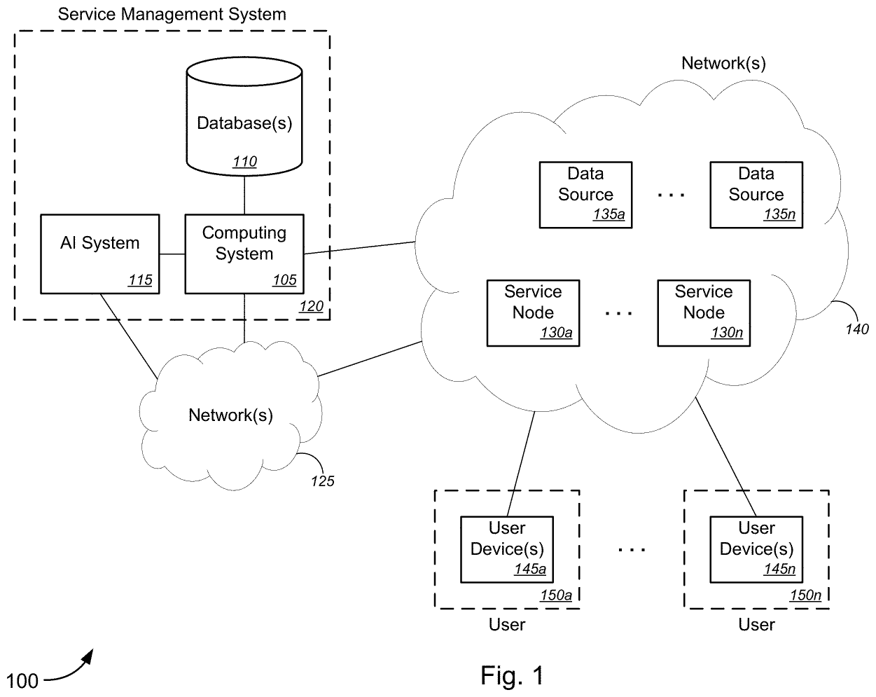

We now turn to the embodiments as illustrated by the drawings. FIGS. 1-6 illustrate some of the features of the method, system, and apparatus for implementing incident prediction and resolution, and, more particularly, to methods, systems, and apparatuses for implementing pattern identification for incident prediction and resolution, as referred to above. The methods, systems, and apparatuses illustrated by FIGS. 1-6 refer to examples of different embodiments that include various components and steps, which can be considered alternatives or which can be used in conjunction with one another in the various embodiments. The description of the illustrated methods, systems, and apparatuses shown in FIGS. 1-6 is provided for purposes of illustration and should not be considered to limit the scope of the different embodiments.

With reference to the figures, FIG. 1 is a schematic diagram illustrating a system 100 for implementing pattern identification for incident prediction and resolution, in accordance with various embodiments.

In the non-limiting embodiment of FIG. 1, system 100 may comprise a computing system 105 and a database(s) 110 that is local to the computing system 105. In some cases, the database(s) 110 may be external, yet communicatively coupled, to the computing system 105. In other cases, the database(s) 110 may be integrated within the computing system 105. System 100, according to some embodiments, may further comprise an artificial intelligence (“AI”) system 115. In some instances, the computing system 105, the database(s) 110, and the AI system 115 may be part of the service management system 120. In some embodiments, the computing system may include, without limitation, at least one of a service management computing system, the AI system, a machine learning system, a deep learning system, a server computer over a network, a cloud computing system, or a distributed computing system, and/or the like.

System 100 may further comprise one or more networks 125, one or more service nodes 130a-130n (collectively, “service nodes 130” or “nodes 130” or the like), one or more data sources 135a-135n (collectively, “data sources 135” or the like), and one or more networks 140. According to some embodiments, the one or more service nodes 130 may include, without limitation, nodes, devices, machines, or systems, and/or the like, that may be used to perform one or more services provided by a service provider to customers. In some embodiments, the one or more data sources 135 may include, but are not limited to, at least one of one or more service management data sources, one or more service incident data sources, one or more warning data sources, one or more event logs, one or more error data sources, one or more alert data sources, one or more human resources data sources, or one or more service team data sources, and/or the like.

In some cases, the one or more networks 125 and the one or more networks 140 may be the same one or more networks. Alternatively, the one or more networks 125 and the one or more networks 140 may be different one or more networks. According to some embodiments, network(s) 125 and/or 140 may each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network(s) 125 and/or 140 may include an access network of the service provider (e.g., an Internet service provider (“ISP”)). In another embodiment, the network(s) 125 and/or 140 may include a core network of the service provider and/or the Internet.

Merely by way of example, in some cases, system 100 may further comprise one or more user devices 145a-145n (collectively, “user devices 145” or the like) that are associated with corresponding users 150a-150n (collectively, “users 150” or the like). According to some embodiments, the one or more user devices 145 may each include, but is not limited to, one of a laptop computer, a desktop computer, a service console, a technician portable device, a tablet computer, a smart phone, a mobile phone, and/or the like. In some embodiments, the one or more users 150 may each include, without limitation, at least one of one or more customers, one or more service agents, one or more service technicians, or one or more service management agents, and/or the like.

In operation, computing system 105 and/or AI system 115 (collectively, “computing system” or the like) may receive a first set of data associated with a service provided by a service provider. In some cases, the first set of data may include, but is not limited to, current data associated with the service and historical data associated with the service, and/or the like. The computing system may analyze the historical data to generate baselining data associated with the service based on a prediction model. The computing system may analyze the current data compared with the baselining data to identify one or more issues associated with the service. The computing system may analyze the identified one or more issues to perform one or more predictions and to determine which of the identified one or more issues require redressal and which of the identified one or more issues can be left without redressal (i.e., issues that may be avoided, or the like), based on the one or more predictions. The computing system may generate and send one or more recommendations regarding which of the identified one or more issues require redressal and which of the identified one or more issues can be left without redressal.

In some cases, the first set of data may include service management input data including, but not limited to, at least one of service management input data, service incident data, warning data, event log data, error data, alert data, human resources input data, or service team input data, and/or the like.

According to some embodiments, the computing system may perform data preprocessing, which may include, without limitation: performing data classification on the first set of data, by providing data labelling to the first set of data based at least in part on type of data; performing data cleaning on the first set of data based at least in part on the data classification to produce second set of data, the second set of data including, but not limited to, non-redundant, non-blank, non-formatted data without punctuations, whitespaces, stop words, and non-conforming data structures, or the like; performing data distribution on the second set of data to produce balanced data based at least in part on data labelling and data classification; performing feature extraction on the balanced data to identify at least one of key features or attributes of data among the balanced data; and performing vectorization on the at least one of the key features or the attributes of data among the balanced data, by assigning probabilities to similar features to conform more closely to the data labelling; and/or the like. In some cases, generating baselining data may be based at least in part on the vectorization performed on the at least one of the key features or the attributes of data among the balanced data, or the like. In some instances, the prediction model may be an AI model, and the computing system may update the prediction model to improve baselining data generation, based at least in part on the vectorization performed on the at least one of the key features or the attributes of data among the balanced data.

In some embodiments, the computing system performing the one or more predictions may include, but are not limited to, at least one of: performing category prediction to classify the identified one or more issues into one or more categories; performing problem prediction to identify one or more problem areas for each of the identified one or more issues; calculating prediction likelihood to determine at least one of likelihood of category prediction being correct or likelihood of problem prediction being correct; or performing anomaly detection and management to identify one or more anomalies among at least one of the identified one or more issues, the historical data associated with the service, or the current data associated with the service, and/or the like; and/or the like. In some cases, determining which of the identified one or more issues require redressal and which of the identified one or more issues can be left without redressal may comprise determining which of the identified one or more issues require redressal and which of the identified one or more issues can be left without redressal based at least in part on at least one of the classified one or more categories, the determined one or more problem areas, the determined likelihood of category prediction being correct, the determined likelihood of problem prediction being correct, or the identified one or more anomalies, and/or the like. In some instances, performing problem prediction may comprise performing active prediction to identify at least one of one or more future incidents, one or more future problems, a relation matrix among at least one of the one or more future problems or the identified one or more problem areas, one or more potential incident trends, one or more potential problem trends, or one or more visualization data adapted to service management, and/or the like. In some cases, the computing system may generate at least one of a potential problem signature or one or more crisis patterns, based at least in part on the active prediction and based at least in part on automated task creation and resolution.

According to some embodiments, determining which of the identified one or more issues require redressal and which of the identified one or more issues can be left without redressal may alternatively or additionally comprise determining which of the identified one or more issues require redressal and which of the identified one or more issues can be left without redressal, by predicting probabilities for one or more future outcomes resulting from at least one of addressing each of the identified one or more issues or leaving unaddressed each of the identified one or more issues, and generating weighted values for each of the recommendations based at least in part on the predicted probabilities for the one or more future outcomes and based at least in part on resource allocation determination for addressing each of the identified one or more issues.

In some embodiments, the computing system may further perform at least one of: generating and sending one or more first instructions to one or more automated nodes among a plurality of nodes associated with, owned by, or operated by the service provider, the one or more first instructions causing the one or more automated nodes to autonomously address the identified one or more issues requiring redressal based on the one or more recommendations; or generating and sending one or more first service tickets to one or more service technicians with instructions and information for addressing the identified one or more issues requiring redressal based on the one or more recommendations; and/or the like.

According to some embodiments, analyzing the historical data and analyzing the current data may be part of a data preprocessing portion, and the computing system may perform a false positive check by using a feedback loop to feed back a selected set of data from the one or more recommendations as input into the data preprocessing portion, where generating the baselining data and identifying the one or more issues may be performed based on the selected set of data. In some instances, the selected set of data may comprise a random recommendation among a first predetermined number of recommendations, the random recommendation being based on a random pattern that is sequentially changed to ensure that the selection is not based on any set pattern. In some cases, a prediction generation logic used to perform problem prediction may be validated against control data for every second predetermined number of recommendations.

Although the embodiments described above are related to service management, the various embodiments are not so limited, and system 100 and the techniques described herein may be used for predicting issues—based at least in part on analysis of historical and current data, baselining, and/or prediction models, or the like—with respect to fields including, but not limited to, telecommunications, banking, web-based banking, flight cancellation, Internet of Things (“IoT”) systems, software applications (“apps”), or other web-based, app-based, server-based, or automated services, and/or the like [referred to herein as “service management applications” or the like], or entertainment content success/failure, game content success/failure, app or software content success/failure, product launch success/failure, polling, trend identification, or other non-service applications, and/or the like [referred to herein as “non-service applications” or the like].

In general, the various embodiments provide for systems and methods that implement pattern identification for incident prediction and resolution that provide optimized service management prediction, baselining, and redressal or avoidance functionality for service management applications (or optimized success/failure prediction, baselining, and redressal or avoidance functionality for non-service applications), and/or the like, while taking into account predicted future outcomes or consequences as well as taking into account resource management (especially for limited resources that may not be sufficient for addressing each and every issue that has been identified, particularly, within limited time windows, or the like). For example, by identifying issues that can be avoided (i.e., left without being addressed or redressed), the limited resources may be reserved for issues that are deemed to be more suitable for immediate redressal. In some cases, the issues recommended for avoidance may be determined, based on predicted future outcomes or consequences, to be potentially self-correcting. Alternatively, the issues recommended for avoidance may be determined, based on predicted future outcomes or consequences, to affect only a very small number of people or regions (or may have a lesser impact) compared with some issues recommended for redressal that may affect a much larger number of people or regions (or may have a greater impact).

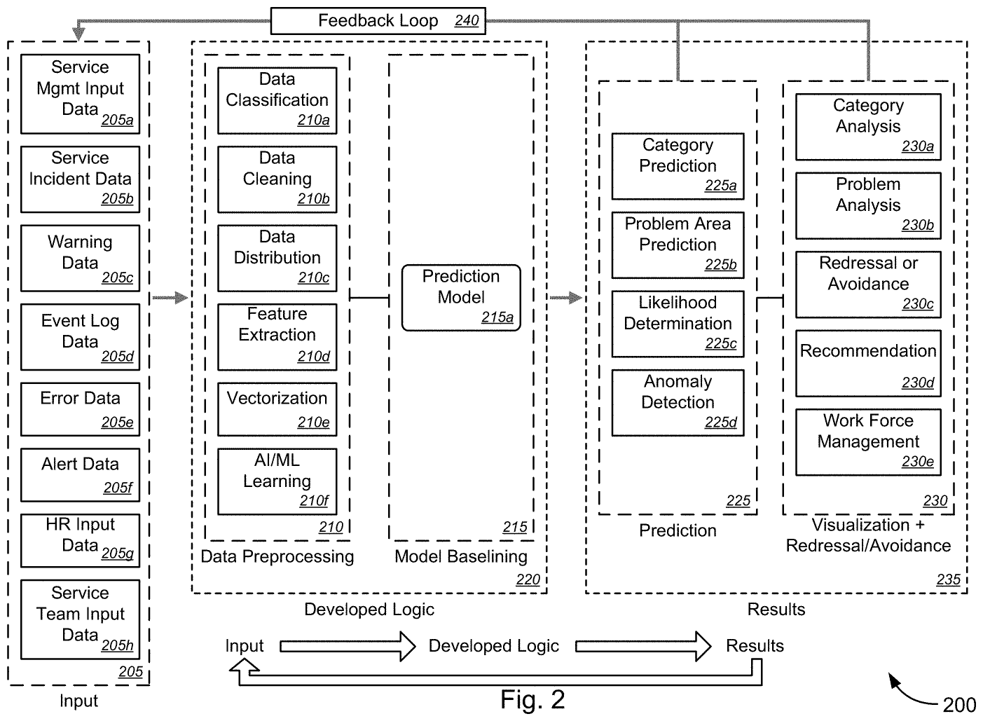

These and other functions of the system 100 (and its components) are described in greater detail below with respect to FIGS. 2-4.

FIG. 2 is a schematic block flow diagram illustrating a non-limiting example method 200 of pattern identification, baselining, prediction, and problem management that may be implemented during pattern identification for incident prediction and resolution, in accordance with various embodiments.

With reference to FIG. 2, pattern identification, baselining, prediction, and problem management, such as described above with respect to FIG. 1 or the like, may utilize input 205, including, but not limited to, at least one of service management input data 205a, service incident data 205b, warning data 205c, event log data 205d, error data 205e, alert data 205f, human resources (“HR”) input data 205g, or service team input data 205h, and/or the like. In some cases, data of two or more of the service management input data 205a, service incident data 205b, warning data 205c, event log data 205d, error data 205e, alert data 205f, human resources (“HR”) input data 205g, or service team input data 205h may overlap or may be the same set of data. In other cases, data of the service management input data 205a, service incident data 205b, warning data 205c, event log data 205d, error data 205e, alert data 205f, human resources (“HR”) input data 205g, or service team input data 205h may be different yet related.

In some embodiments, the service management input data 205a may include data that may be used to monitor, diagnose, track, and/or affect the service provided to customers, while the service incident data 205b may include data that corresponds to service incidents (e.g., service outages, service errors, service congestion, or the like). The warning data 205c may include data corresponding to warnings sent by service machines, service devices, service nodes, service systems, and/or service communications systems, or the like. The event log data 205d may include data corresponding to event logs that track service events, or the like. The error data 205e may include data corresponding to errors in providing the services to the customers, while the alert data 205f may include data that alerts service provider agents to current issues, current incidents, current events, potential issues, potential incidents, or potential events, and/or the like. The human resources (“HR”) input data 205g may include data corresponding to personnel data of service agents and/or service technicians who may be enlisted to facilitate provisioning of services to the customers and/or to address issues or incidents that have occurred during provisioning of the services to the customers, while service team input data 205h may include data that may be used by service team members or service team leaders to facilitate assignment of tasks for facilitating provisioning of services to the customers and/or addressing issues or incidents that have occurred during provisioning of the services to the customers, or the like.

Data preprocessing 210 may be performed on the input data 205, the data preprocessing 210 including, without limitation, at least one of data classification 210a, data cleaning 210b, data distribution 210c, feature extraction 210d, vectorization 210e, and/or artificial intelligence (“AI”) or machine learning (“ML”) learning or training 210f, and/or the like. Model baselining 215 may be performed on the output of the data preprocessing 210, in some cases, using a prediction model 215a. Data preprocessing 210 and model baselining 215 may be part of developed logic 220.

Data classification 210a may include performing classification of input data 205, by providing data labelling to the input data 205 based at least in part on type of data, or the like. Data cleaning 210b may include performing cleaning of input data 205, in some cases, based at least in part on the data classification to produce second set of data, where the second set of data may include, without limitation, non-redundant, non-blank, non-formatted data without punctuations, whitespaces, stop words, and non-conforming data structures, or the like. Data distribution 210c may include performing data distribution on the second set of data to produce balanced data, in some cases, based at least in part on data labelling and data classification. Feature extraction 210d may include performing extraction of features from the balanced data to identify at least one of key features or attributes of data among the balanced data. Vectorization 210e may include performing vectorization on the at least one of the key features or the attributes of data among the balanced data, by assigning probabilities to similar features to conform more closely to the data labelling. AI or ML learning or training 210f may include performing updating the prediction model 215a (which may be an AI model, or the like) to improve baselining data generation, based at least in part on the vectorization performed on the at least one of the key features or the attributes of data among the balanced data.

Predictions 225 may be performed on current data among the input data 205 to identify one or more issues associated with the service, based at least in part on the prediction model 215a and/or the model baselining 215. Performing the predictions 225 may include, but is not limited to, at least one of: performing category prediction 225a to classify the identified one or more issues into one or more categories; performing problem prediction 225b to identify one or more problem areas for each of the identified one or more issues; calculating prediction likelihood 225c to determine at least one of likelihood of category prediction being correct or likelihood of problem prediction being correct; or performing anomaly detection and management 225d to identify one or more anomalies among at least one of the identified one or more issues, the historical data associated with the service, or the current data associated with the service; and/or the like. In some cases, performing problem prediction may comprise performing active prediction to identify at least one of one or more future incidents, one or more future problems, a relation matrix among at least one of the one or more future problems or the identified one or more problem areas, one or more potential incident trends, one or more potential problem trends, or one or more visualization data adapted to service management, and/or the like.

Visualization and redressal or avoidance 230 may be performed based on the prediction 225, and may include, without limitation, category analysis 230a, problem analysis 230b, redressal or avoidance 230c, recommendation 230d, and/or work force management 230e, or the like. Prediction 225 and Visualization and redressal or avoidance 230 may be part of the results 235. Category analysis 230a may include analyzing the predicted categories output by category prediction 225a, while problem analysis 230b may include analyzing the predicted problem areas output by problem area prediction 225b. In some cases, category analysis 230a and problem analysis 230b may each or both include, but is not limited to, matching the predicted category and/or the predicted problem areas with previously identified issues with established categories and problem areas (in some instances, determining percentages of match between the predicted category and/or the predicted problem areas and the previously identified issues with established categories and problem areas, or the like), and/or identifying outliers (in some instances, determining whether each current issue or similar issue has occurred previously, determining how long ago each current issue or similar issue last occurred, determining whether each current issue represents or corresponds to a new problem area, or the like), or the like.

Redressal or avoidance 230c may include determining which (identified) current issues may need to be addressed (or may require redressal), determining which (identified) current issues may need to be readdressed (or may require further redressal), or determining which (identified) current issues may be avoided (or may be left without being addressed or redressed), and/or the like. Recommendation 230d may include generating and sending one or more recommendations regarding which of the (identified) current issues require redressal and which of the (identified) current issues can be left without redressal.

In some embodiments, determining which of the (identified) current issues require redressal (or further redressal) and which of the (identified) current issues can be left without redressal may comprise determining which of the (identified) current issues require redressal and which of the (identified) current issues can be left without redressal based at least in part on at least one of the classified one or more categories, the determined one or more problem areas, the determined likelihood of category prediction being correct, the determined likelihood of problem prediction being correct, or the identified one or more anomalies, and/or the like. Alternatively, or additionally, determining which of the (identified) current issues require redressal and which of the (identified) current issues can be left without redressal may comprise determining which of the (identified) current issues require redressal and which of the (identified) current issues can be left without redressal, by predicting probabilities for one or more future outcomes resulting from at least one of addressing each of the (identified) current issues or leaving unaddressed each of the (identified) current issues, and generating weighted values for each of the recommendations based at least in part on the predicted probabilities for the one or more future outcomes and based at least in part on resource allocation determination for addressing each of the (identified) current issues.

Work force management 230e may include, without limitation, at least one of: generating and sending one or more first instructions to one or more automated nodes among a plurality of nodes associated with, owned by, or operated by the service provider, the one or more first instructions causing the one or more automated nodes to autonomously address the identified one or more issues requiring redressal based on the one or more recommendations; or generating and sending one or more first service tickets to one or more service technicians with instructions and information for addressing the identified one or more issues requiring redressal based on the one or more recommendations; and/or the like.

The results 235 may be fed back via feedback loop 240 to input 205. In some cases, a false positive check may be performed by using feedback loop 240 to feed back a selected set of data from the one or more recommendations as input 205 into the data preprocessing portion 210. In some instances, generating the baselining data and identifying the one or more issues may be performed based on the selected set of data.

These and other functions of the system 100 (and its components) are described in greater detail below with respect to FIGS. 1, 3, and 4.

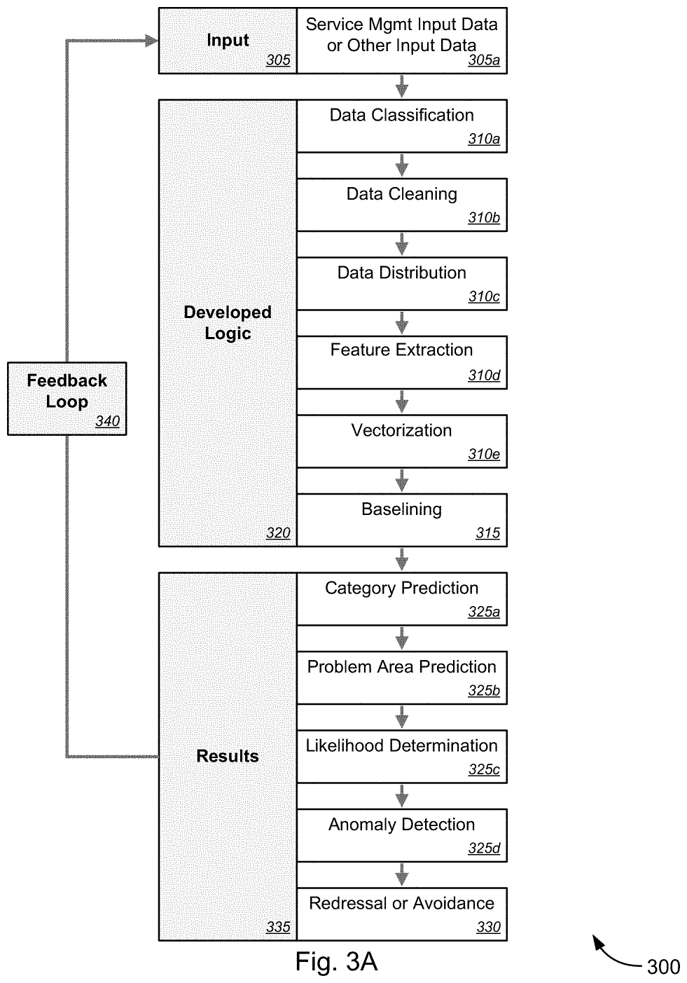

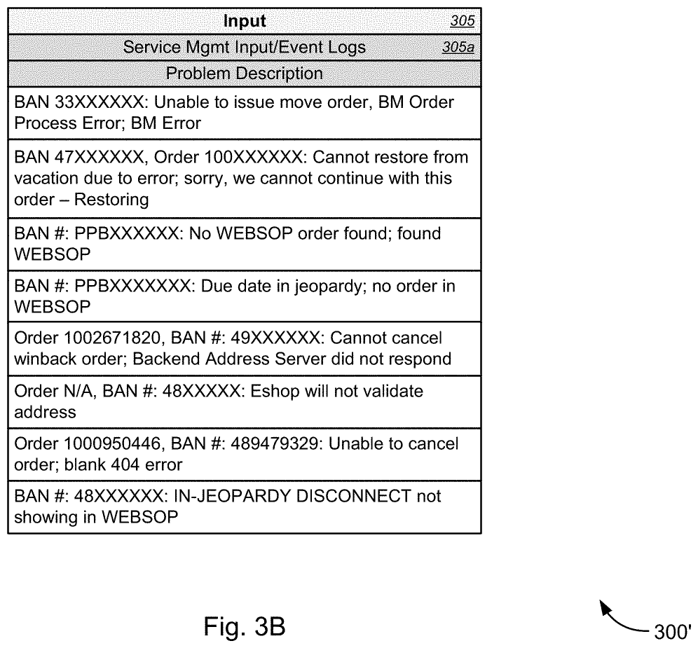

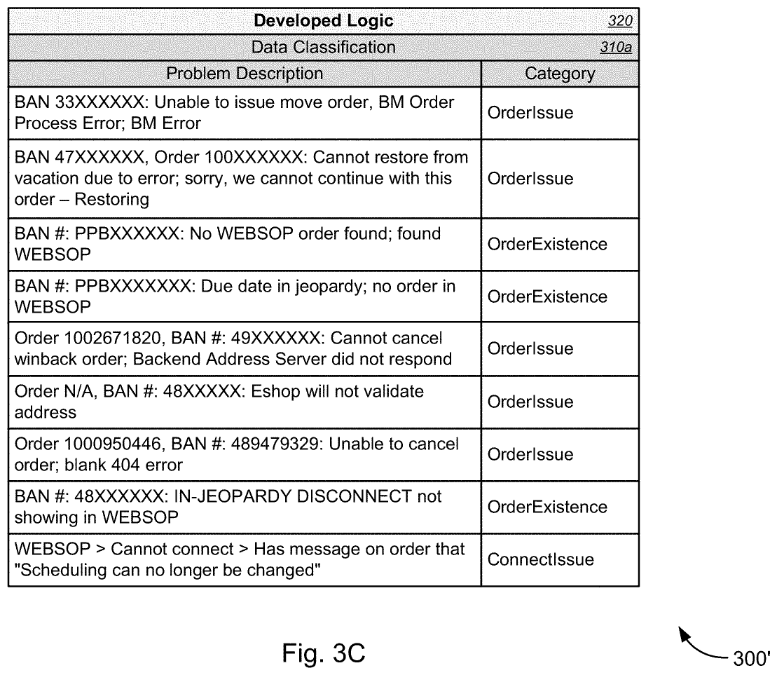

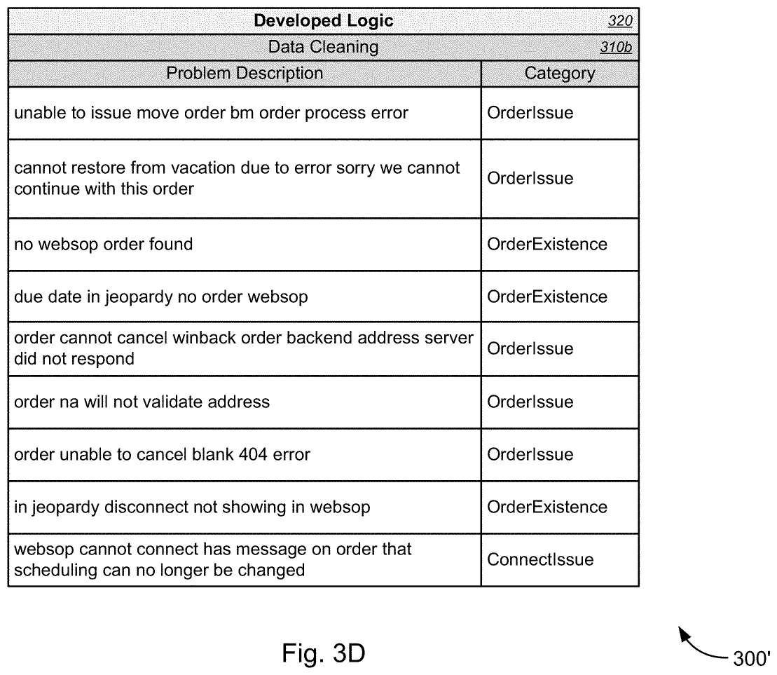

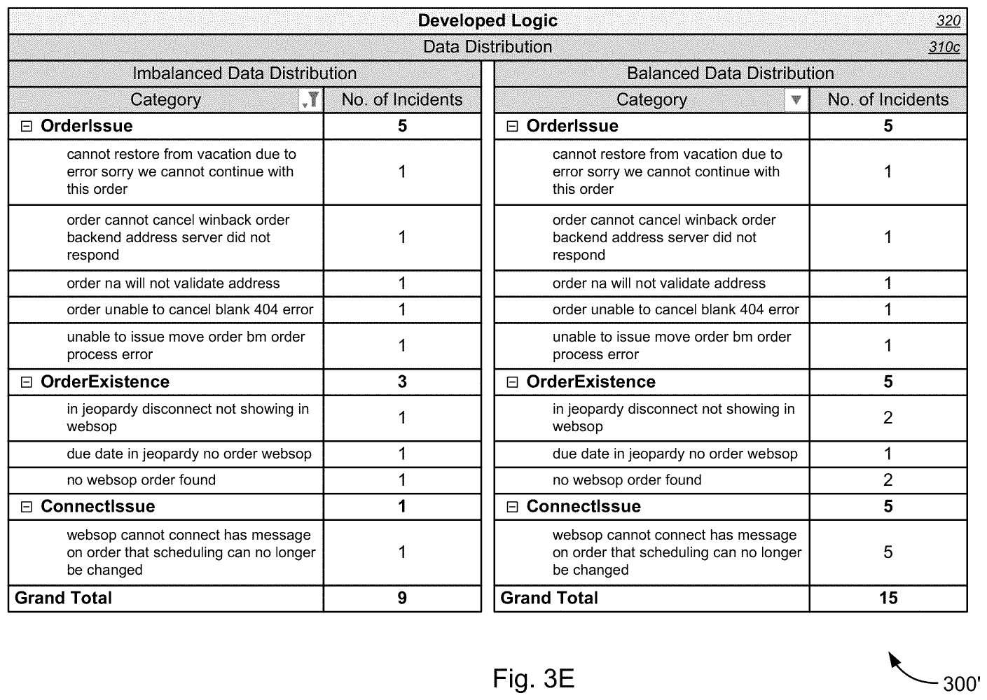

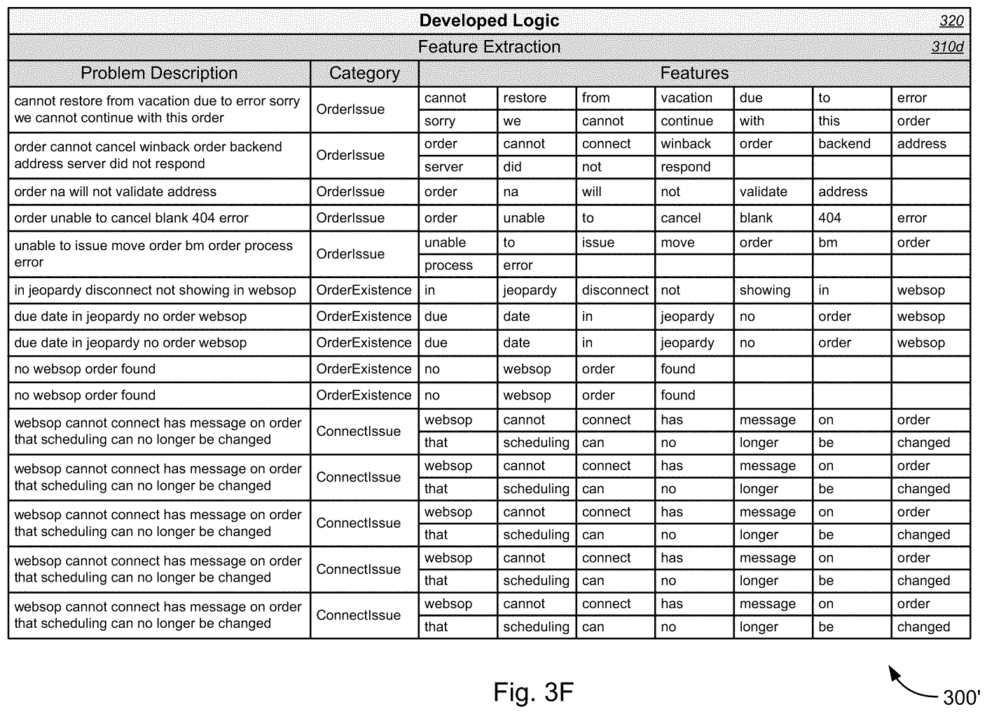

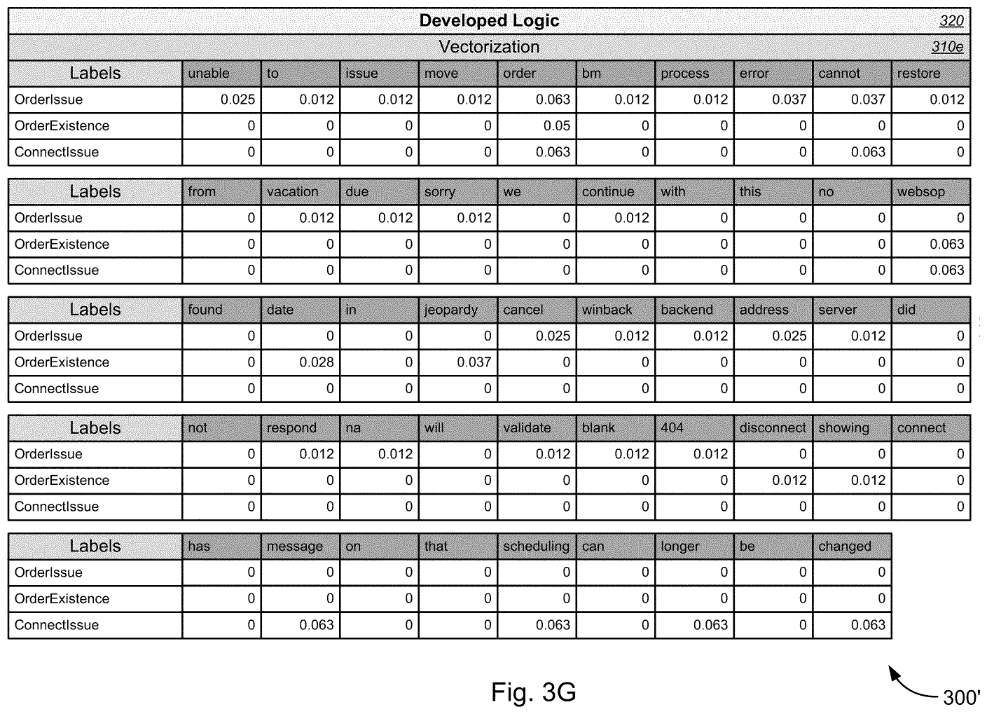

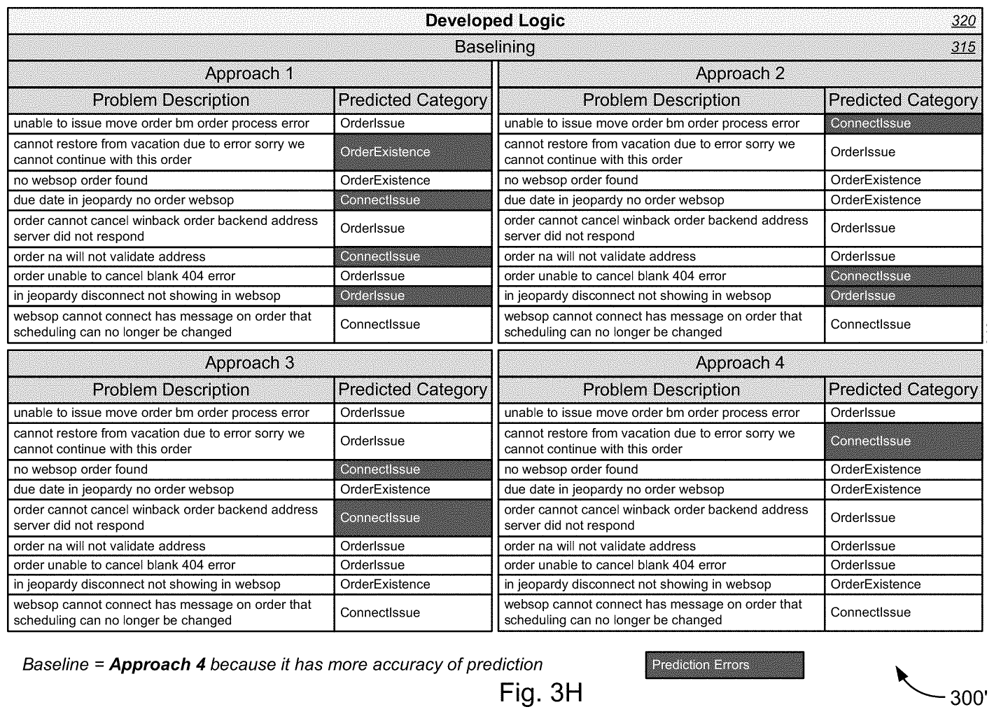

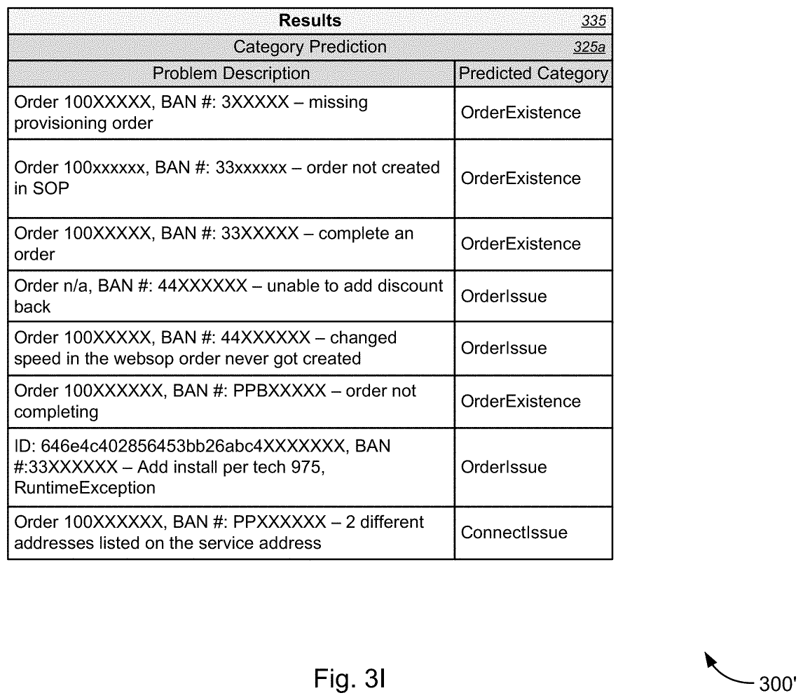

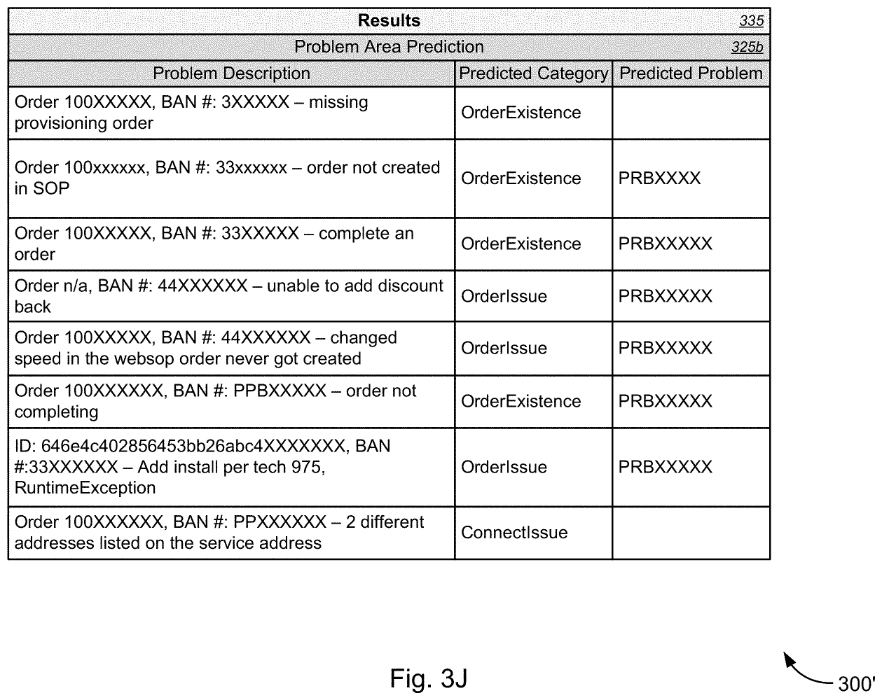

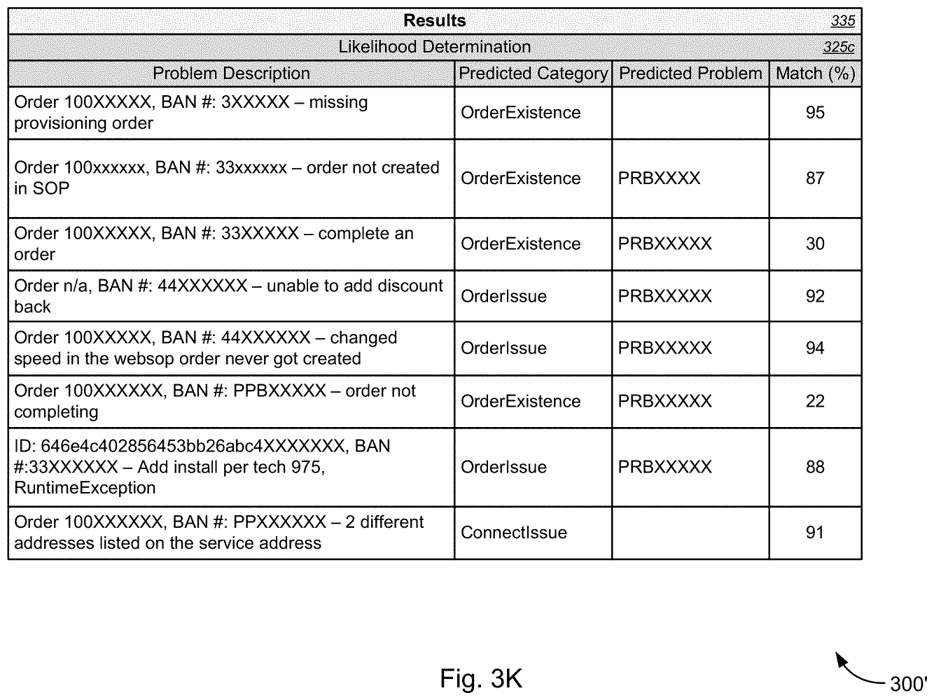

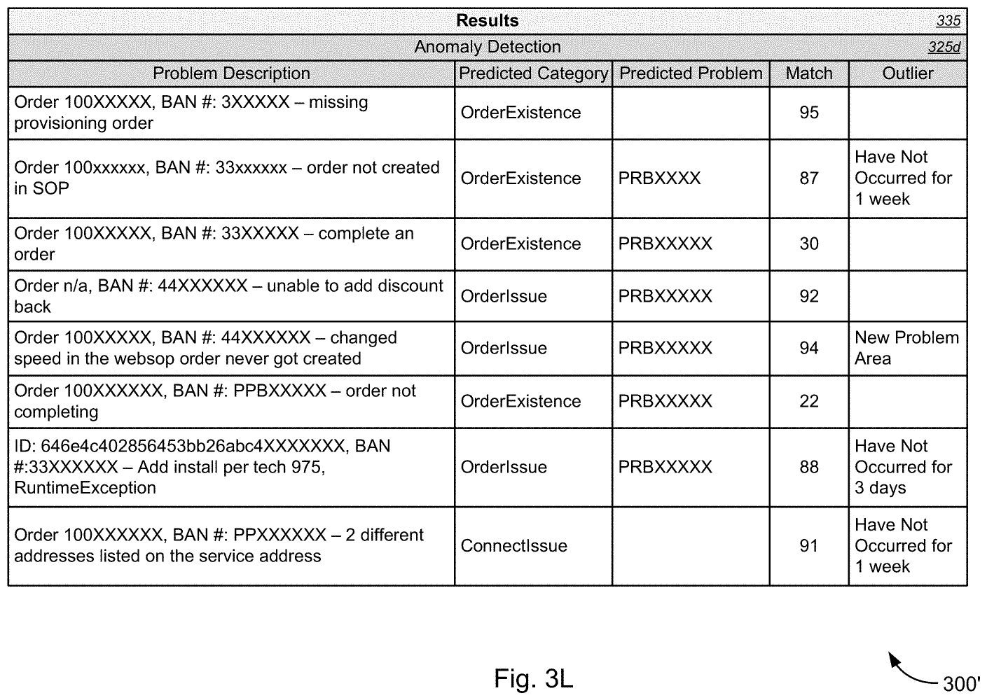

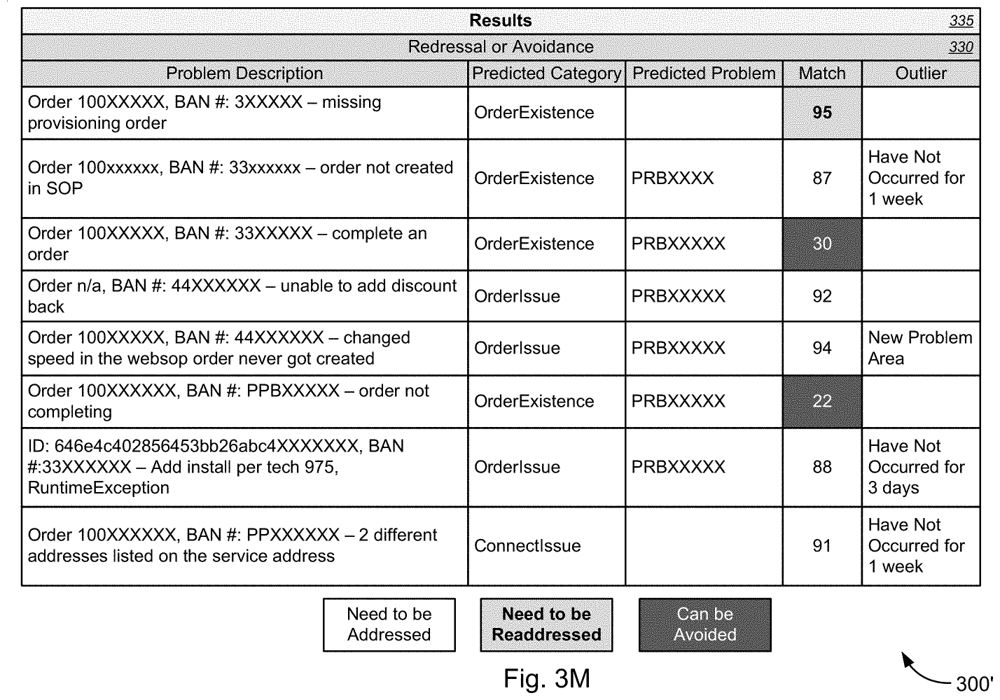

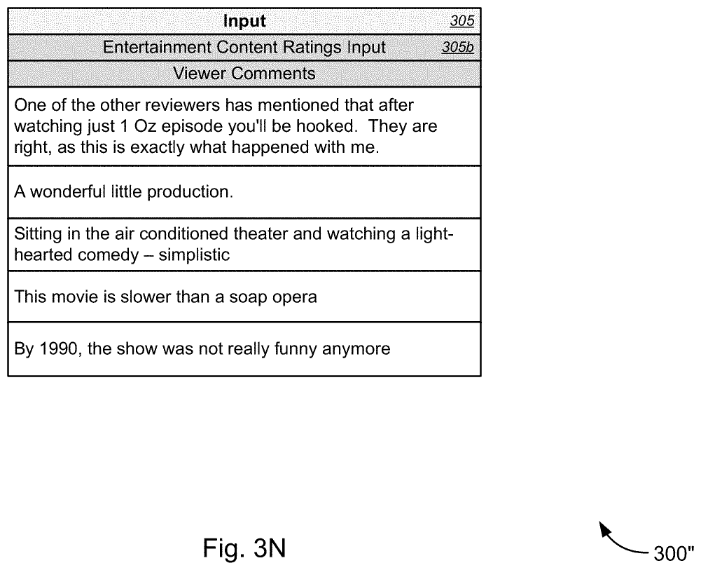

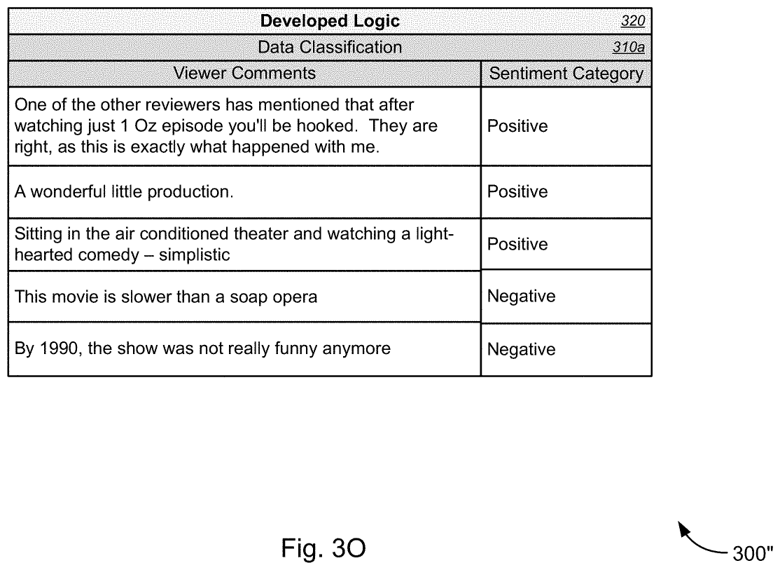

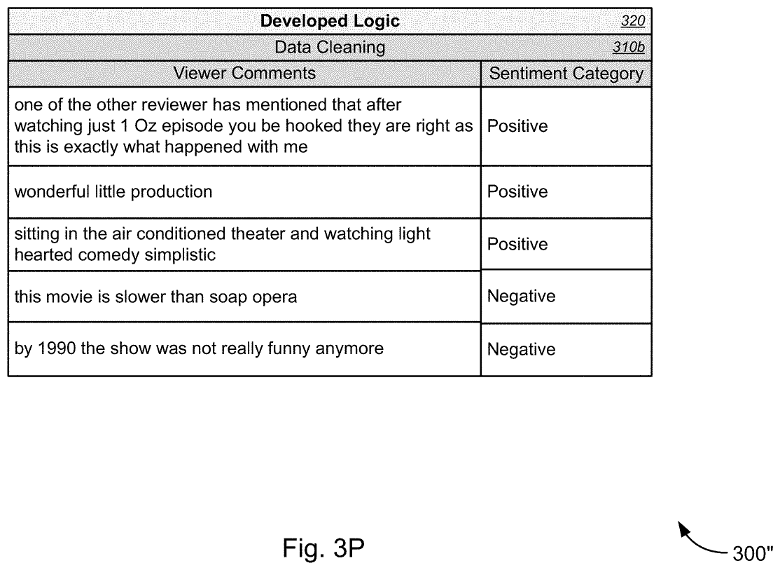

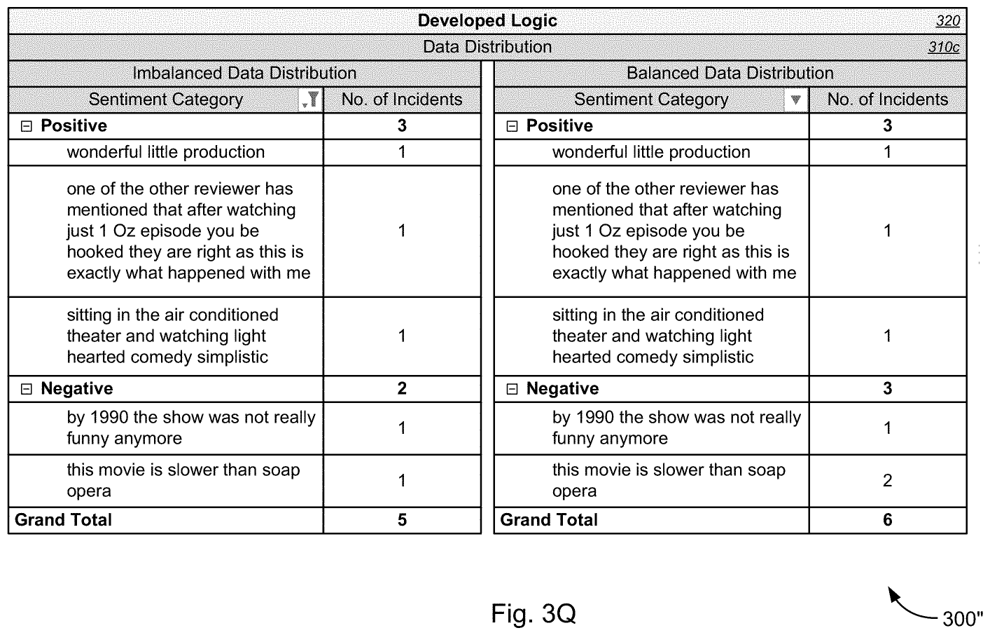

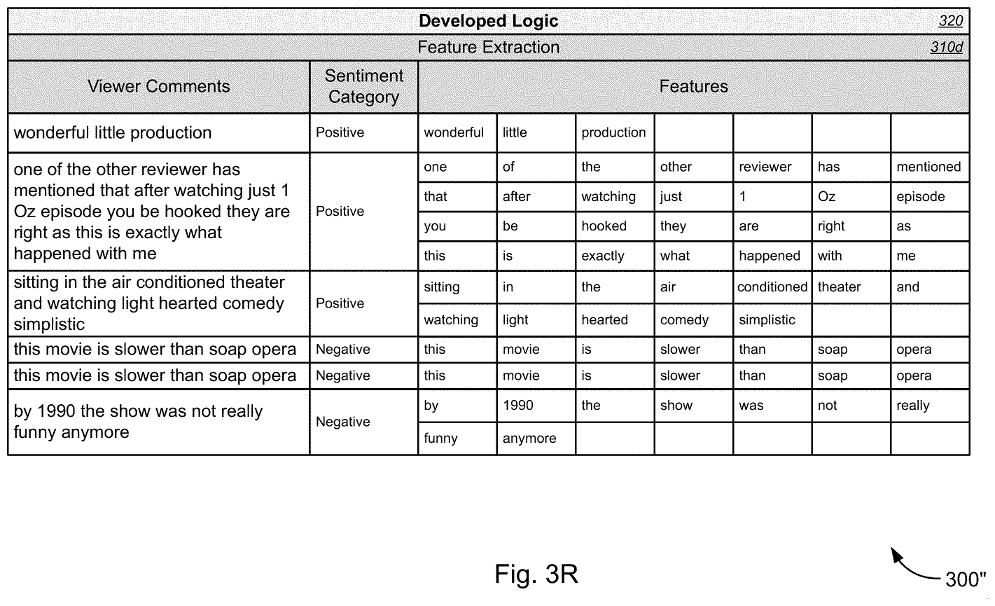

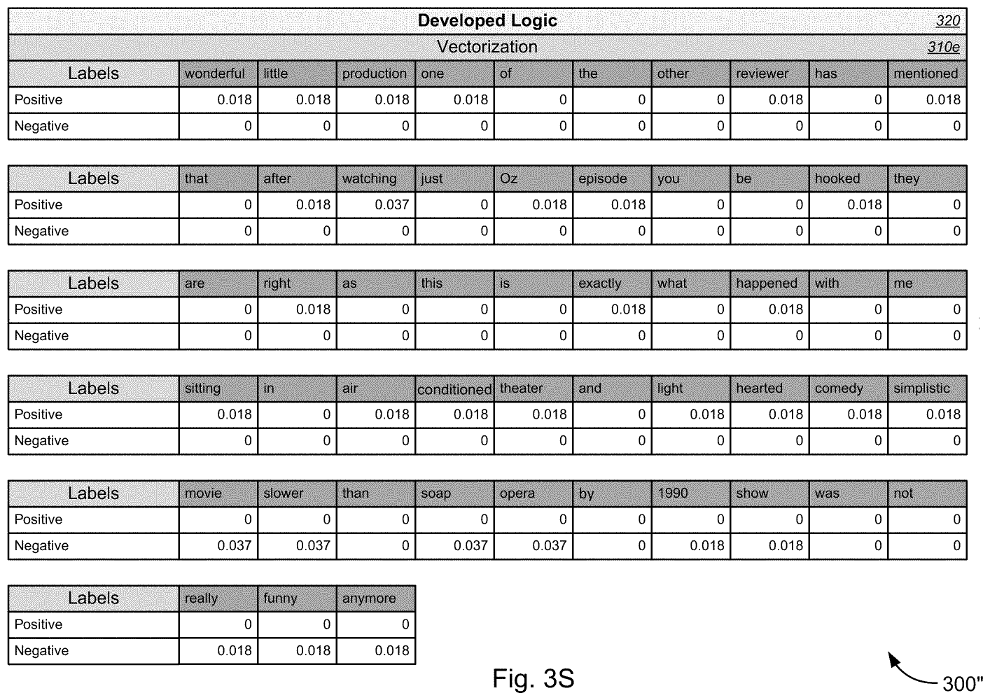

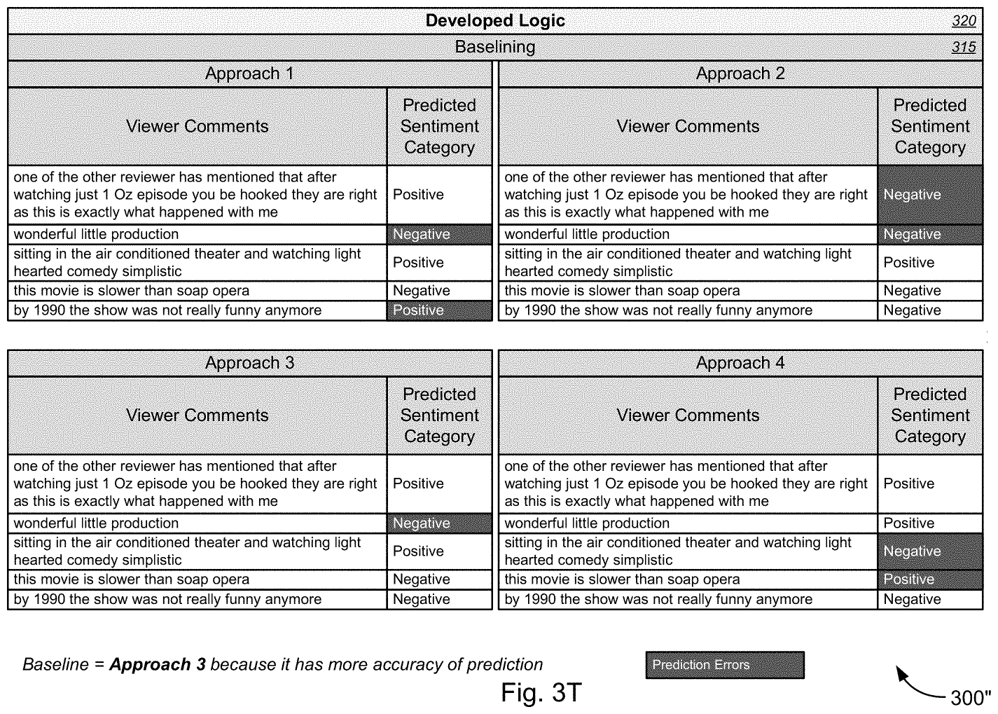

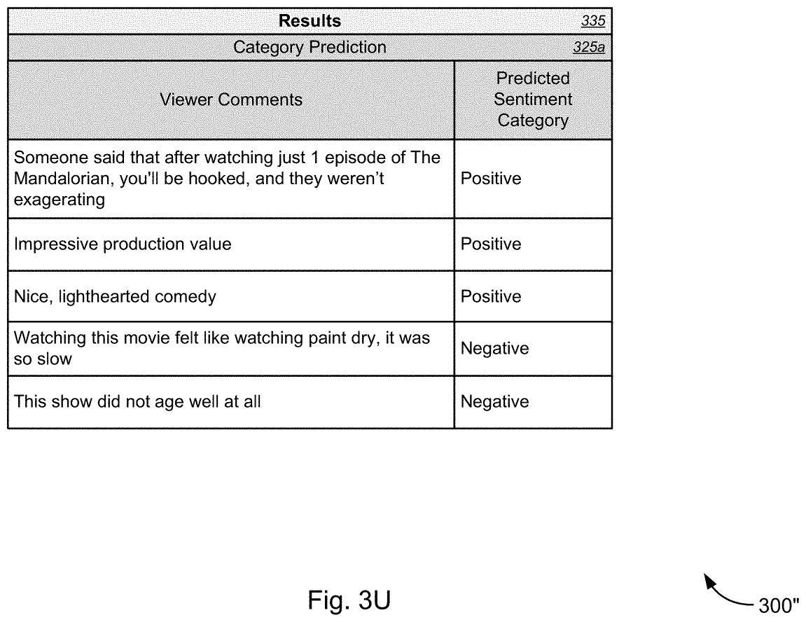

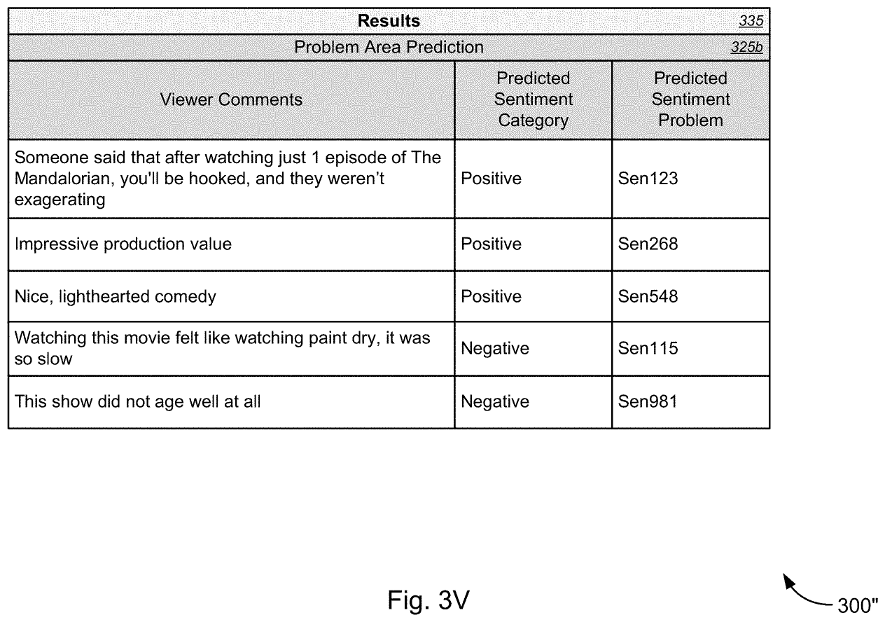

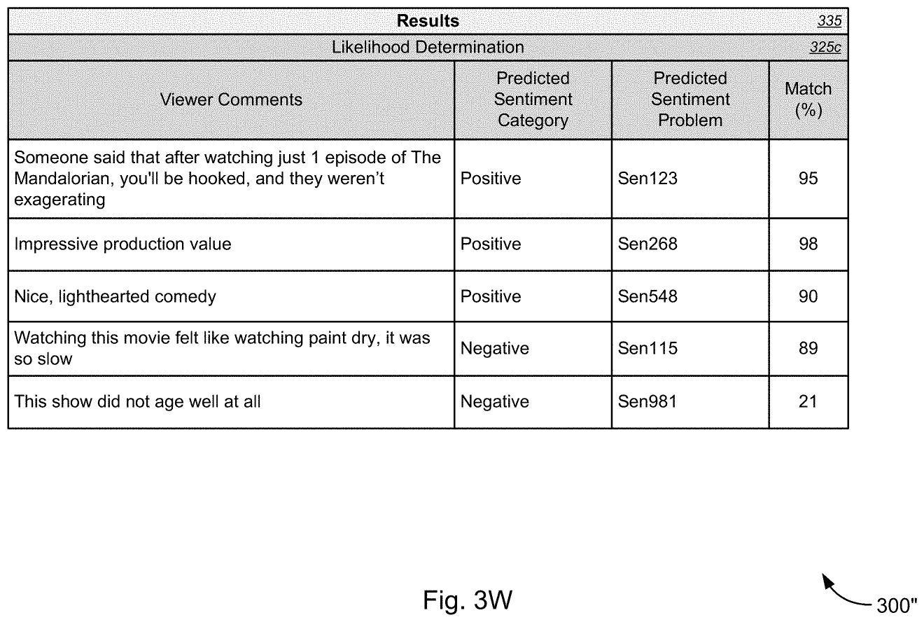

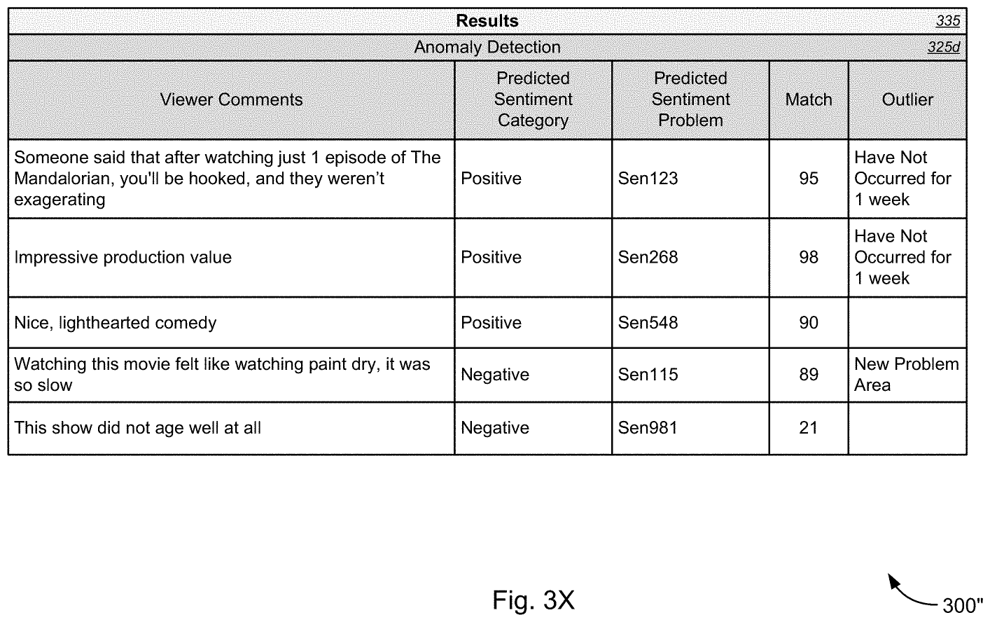

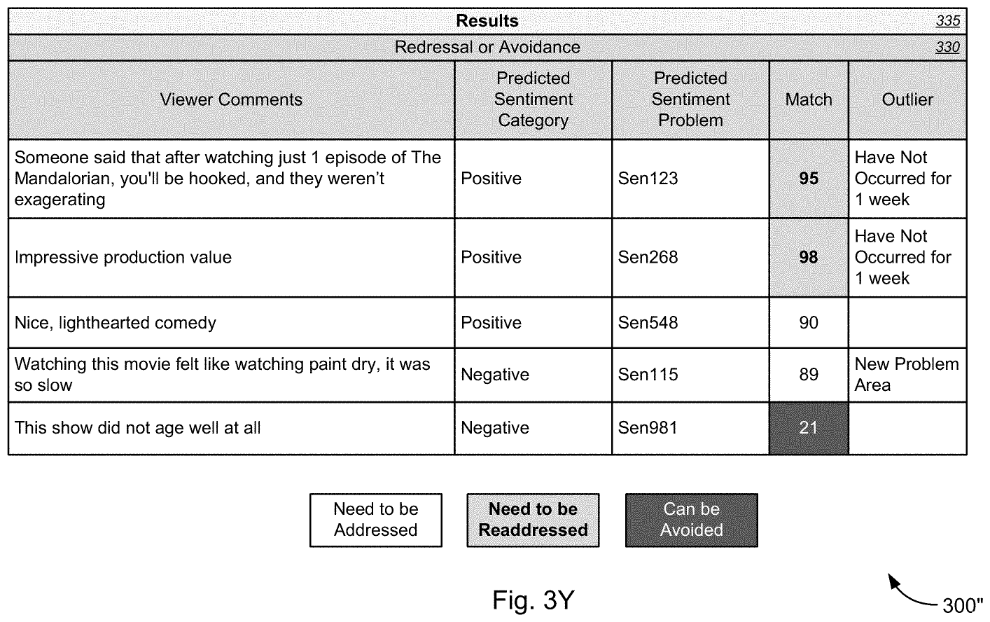

FIGS. 3A-3Y (collectively, “FIG. 3”) are schematic diagrams illustrating various non-limiting examples of pattern identification, baselining, prediction, and problem management that may be implemented during pattern identification for incident prediction and resolution, in accordance with various embodiments. FIG. 3A is a schematic block flow diagram illustrating another non-limiting example method 300 of pattern identification, baselining, prediction, and problem management that may be implemented during pattern identification for incident prediction and resolution, in accordance with various embodiments. FIGS. 3B-3M are schematic diagrams illustrating a non-limiting example service management use case 300′ that depicts implementation of pattern identification, baselining, prediction, and problem management during pattern identification for incident prediction and resolution, in accordance with various embodiments. FIGS. 3N-3Y are schematic diagrams illustrating a non-limiting example entertainment content ratings use case 300″ that depicts implementation of pattern identification, baselining, prediction, and problem management during pattern identification for incident prediction and resolution, in accordance with various embodiments.

With reference to FIG. 3A, pattern identification, baselining, prediction, and problem management, such as described above with respect to FIGS. 1 and 2 or the like, may utilize input 305, developed logic 320, results 335, and feedback loop 340, or the like. Input 305 may include service management input data and/or other input data 305a (collectively, “input data 305a” or the like; which may include, but is not limited to, service incident data, warning data, event log data, error data, alert data, HR input data, service team input data, or other data, and/or the like). Developed logic 320 may include data classification 310a, data cleaning 310b, data distribution 310c, feature extraction 310d, vectorization 310e, and baselining 315, or the like. Results 335 may include category prediction 325a, problem area prediction 325b, likelihood determination 325c, anomaly detection 325d, and redressal or avoidance 330, or the like.

Data classification 310a may include performing classification of input data 305a, by providing data labelling to the input data 305a based at least in part on type of data, or the like. Data cleaning 310b may include performing cleaning of input data 305a, in some cases, based at least in part on the data classification to produce second set of data, where the second set of data may include, without limitation, non-redundant, non-blank, non-formatted data without punctuations, whitespaces, stop words, and non-conforming data structures, or the like. Data distribution 310c may include performing data distribution on the second set of data to produce balanced data, in some cases, based at least in part on data labelling and data classification. Feature extraction 310d may include performing extraction of features from the balanced data to identify at least one of key features or attributes of data among the balanced data. Vectorization 310e may include performing vectorization on the at least one of the key features or the attributes of data among the balanced data, by assigning probabilities to similar features to conform more closely to the data labelling. Baselining 315 may include generating data baselining, in some cases, based at least in part on the vectorization performed on the at least one of the key features or the attributes of data among the balanced data.

Category prediction 325a may include performing classification of identified one or more issues into one or more categories. Problem prediction 325b may include performing identification of one or more problem areas for each of the identified one or more issues. In some cases, performing problem prediction may comprise performing active prediction to identify at least one of one or more future incidents, one or more future problems, a relation matrix among at least one of the one or more future problems or the identified one or more problem areas, one or more potential incident trends, one or more potential problem trends, or one or more visualization data adapted to service management, and/or the like. Likelihood determination 325c may include performing determination or identification of at least one of likelihood of category prediction being correct or likelihood of problem prediction being correct. Anomaly detection and management 325d may include performing identification of one or more anomalies among at least one of the identified one or more issues, the historical data associated with the service, or the current data associated with the service; and/or the like.

Redressal or avoidance 330 may include determining which identified one or more issues may need to be addressed (or may require redressal), determining which identified one or more issues may need to be readdressed (or may require further redressal), or determining which identified one or more issues may be avoided (or may be left without being addressed or redressed), and/or the like.

In some embodiments, determining which of the identified one or more issues require redressal (or further redressal) and which of the identified one or more issues can be left without redressal may comprise determining which of the identified one or more issues require redressal and which of the identified one or more issues can be left without redressal based at least in part on at least one of the classified one or more categories, the determined one or more problem areas, the determined likelihood of category prediction being correct, the determined likelihood of problem prediction being correct, or the identified one or more anomalies, and/or the like. Alternatively, or additionally, determining which of the identified one or more issues require redressal and which of the identified one or more issues can be left without redressal may comprise determining which of the identified one or more issues require redressal and which of the identified one or more issues can be left without redressal, by predicting probabilities for one or more future outcomes resulting from at least one of addressing each of the identified one or more issues or leaving unaddressed each of the identified one or more issues, and generating weighted values for each of the recommendations based at least in part on the predicted probabilities for the one or more future outcomes and based at least in part on resource allocation determination for addressing each of the identified one or more issues.

With reference to FIGS. 3B-3M, a service management use case 300′ is depicted that illustrates the pattern identification, baselining, prediction, and problem management during pattern identification for incident prediction and resolution of FIG. 3A. In particular, input 305 from service management input or event logs 305a (as shown in FIG. 3B, or the like) may be preprocessed using developed logic 320 by performing data classification 310a to identify one or more categories (in this case, “OrderIssue,” “OrderExistence,” “ConnectIssue,” or the like) (as shown in FIG. 3C, or the like). Data cleaning 310b may be performed to produce problem description that includes non-redundant, non-blank, non-formatted data without punctuations, whitespaces, stop words, and non-conforming data structures, or the like (as shown in FIG. 3D, or the like). Data distribution 310c may be performed to balance any imbalanced data distributions (as shown in FIG. 3E, or the like). Feature extraction 310d may be performed to extract features (in this case, words of in the data cleaned problem descriptions, as shown in FIG. 3F, or the like). Vectorization 310e may be performed on the extracted features (as shown in FIG. 3G, or the like). Baselining 315 may be performed to test various baselining prediction model approaches (four examples of which are shown, e.g., in FIG. 3H, or the like). As shown in FIG. 3H, the prediction model approach having the most accuracy of prediction of categories compared with actual categories may be set as the baseline (in this case, Approach 4).

Results 335 may be performed. For example, category prediction 325a may be performed on current issues to identify predicted categories (as shown in FIG. 3I, or the like). Problem area prediction 325b may be performed to identify predicted problems (as shown in FIG. 3J, or the like). Likelihood determination 325c may be performed to determine at least one of likelihood of category prediction being correct or likelihood of problem prediction being correct, in some cases, determining percentages of match between the predicted category and/or the predicted problem areas and the previously identified issues with established categories and problem areas, or the like (as shown in FIG. 3K, or the like). Anomaly detection 325d may be performed to identify any outliers (in some instances, determining whether each current issue or similar issue has occurred previously, determining how long ago each current issue or similar issue last occurred, determining whether each current issue represents or corresponds to a new problem area, or the like), or the like (as shown in FIG. 3L, or the like). Redressal or avoidance 330 may be performed that includes determining which identified one or more issues may need to be addressed (or may require redressal), determining which identified one or more issues may need to be readdressed (or may require further redressal), or determining which identified one or more issues may be avoided (or may be left without being addressed or redressed), and/or the like (as shown in FIG. 3M, or the like).

Referring to FIGS. 3N-3Y, an entertainment content ratings use case 300″ is depicted that illustrates the pattern identification, baselining, prediction, and problem management during pattern identification for incident prediction and resolution of FIG. 3A. In particular, input 305 from entertainment content ratings input 305b (as shown in FIG. 3N, or the like) may be preprocessed using developed logic 320 by performing data classification 310a to identify one or more categories (in this case, “Positive,” “Negative,” or the like) (as shown in FIG. 3O, or the like). Data cleaning 310b may be performed to produce problem description that includes non-redundant, non-blank, non-formatted data without punctuations, whitespaces, stop words, and non-conforming data structures, or the like (as shown in FIG. 3P, or the like). Data distribution 310c may be performed to balance any imbalanced data distributions (as shown in FIG. 3Q, or the like). Feature extraction 310d may be performed to extract features (in this case, words of in the data cleaned problem descriptions, as shown in FIG. 3R, or the like). Vectorization 310e may be performed on the extracted features (as shown in FIG. 3S, or the like). Baselining 315 may be performed to test various baselining prediction model approaches (four examples of which are shown, e.g., in FIG. 3T, or the like). As shown in FIG. 3T, the prediction model approach having the most accuracy of prediction of categories compared with actual categories may be set as the baseline (in this case, Approach 3).

Results 335 may be performed. For example, category prediction 325a may be performed on current issues to identify predicted categories (as shown in FIG. 3U, or the like). Problem area prediction 325b may be performed to identify predicted problems (as shown in FIG. 3V, or the like). Likelihood determination 325c may be performed to determine at least one of likelihood of category prediction being correct or likelihood of problem prediction being correct, in some cases, determining percentages of match between the predicted category and/or the predicted problem areas and the previously identified issues with established categories and problem areas, or the like (as shown in FIG. 3W, or the like). Anomaly detection 325d may be performed to identify any outliers (in some instances, determining whether each current issue or similar issue has occurred previously, determining how long ago each current issue or similar issue last occurred, determining whether each current issue represents or corresponds to a new problem area, or the like), or the like (as shown in FIG. 3X, or the like). Redressal or avoidance 330 may be performed that includes determining which identified one or more issues may need to be addressed (or may require redressal), determining which identified one or more issues may need to be readdressed (or may require further redressal), or determining which identified one or more issues may be avoided (or may be left without being addressed or redressed), and/or the like (as shown in FIG. 3Y, or the like).

Although the embodiments described above are related to service management or entertainment ratings, the various embodiments are not so limited, and the techniques described herein may be used for predicting issues—based at least in part on analysis of historical and current data, baselining, and/or prediction models, or the like—with respect to fields including, but not limited to, telecommunications, banking, web-based banking, flight cancellation, Internet of Things (“IoT”) systems, software applications (“apps”), or other web-based, app-based, server-based, or automated services, and/or the like [referred to herein as “service management applications” or the like], or entertainment content success/failure, game content success/failure, app or software content success/failure, product launch success/failure, polling, trend identification, or other non-service applications, and/or the like [referred to herein as “non-service applications” or the like].

For service management applications (such as for telecommunications, banking, web-based banking, flight cancellation, IoT systems, apps, or other web-based, app-based, server-based, or automated services, or the like), the system and methods described herein are focused on baselining based on historical service-related data, predicting categories and problem areas using current service-related data, and determining (and recommending) whether (and how) such identified issues should be addressed (or redressed) or whether, based on such prediction and determination of future consequences and outcomes, such identified issues can be avoided (i.e., left without being addressed or redressed).

With respect to non-service applications (e.g., for entertainment content success/failure, game content success/failure, app or software content success/failure, product launch success/failure, polling, trend identification, or other non-service applications, and/or the like), the system and methods described herein are focused on baselining based on historical data (e.g., comments, ratings, social media feed content, or other opinion information from people (e.g., viewers/listeners/players/users, critics, etc.); measures of success or failure (e.g., box office results, recorded television viewership levels, book sales, content service membership subscription increases or decreases, syndication information, number of social media mentions, or other measurable indicia of success or failure, or the like); etc.), predicting positive (or successfulness) or negative (or failure) likelihood for similar content, poll, products, potential trends, etc., based on initial and/or current data (e.g., early reviews and consumer feedback, information from beta groups, information from product testers, information from test viewers, information from beta testers, information from listeners, information from gamers, information from players, information from app users, etc.), determining (and recommending) whether (and how) such identified issues should be addressed (or redressed) or whether, based on such prediction and determination of future consequences and outcomes, such identified issues can be avoided (i.e., left without being addressed or redressed). For redressal, early feedback may be used to rework marketing efforts or to change portions of the content (e.g., deleting or adding scenes in a movie or television show; recasting, removing, or adding characters; removing, changing, or covering controversial items, objects, or imagery; etc.), or in the case of games, apps, or other software, changing features or interfaces (e.g., adding, changing, or deleting features or functionalities; changing interface options or characteristics; etc.).

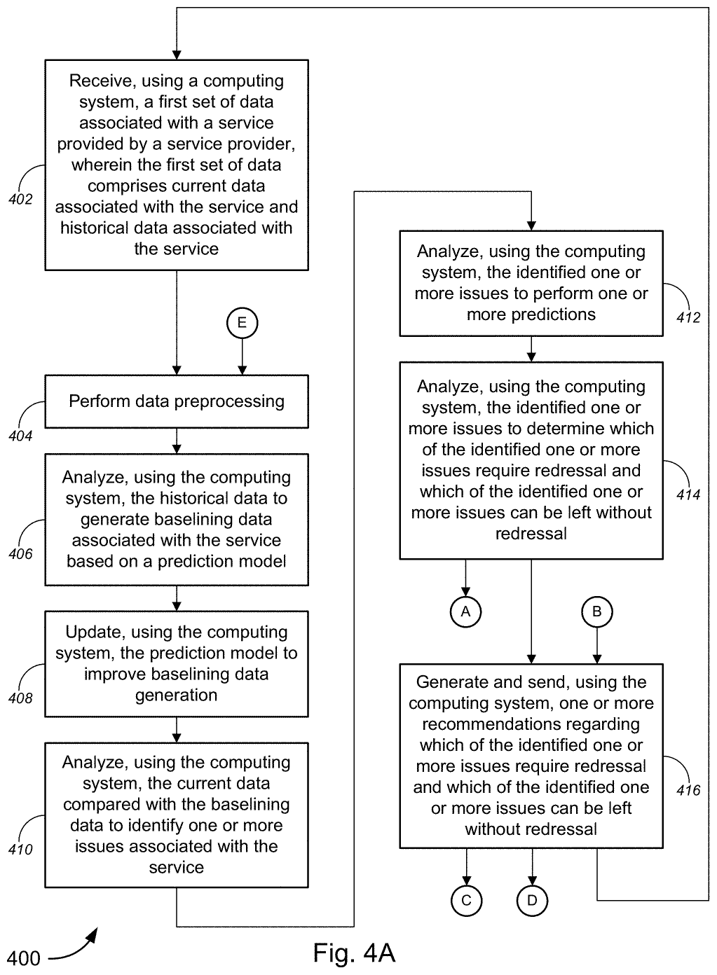

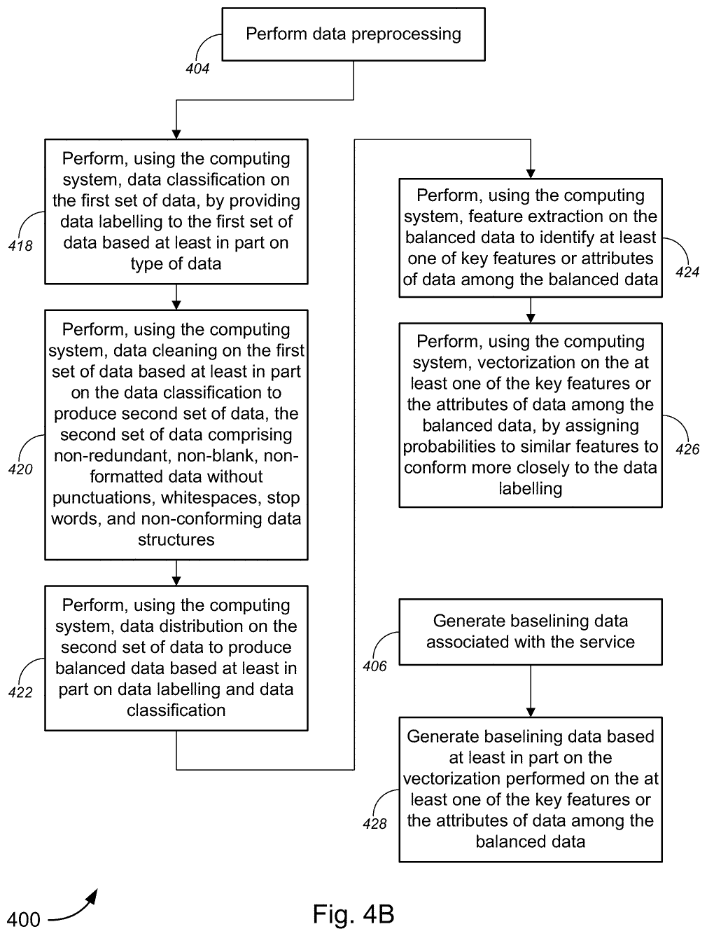

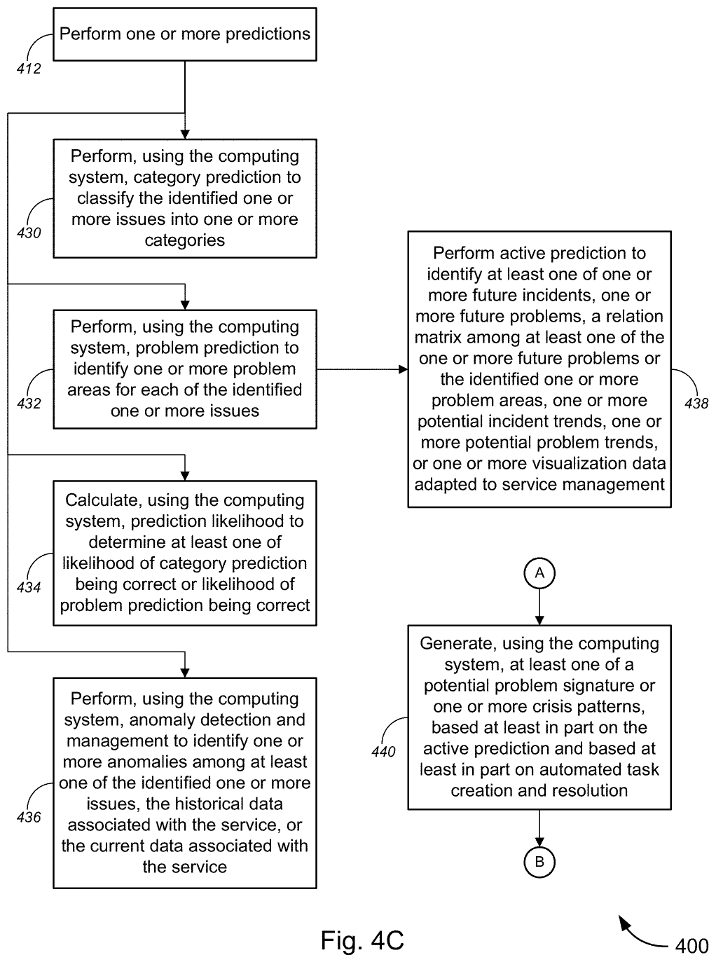

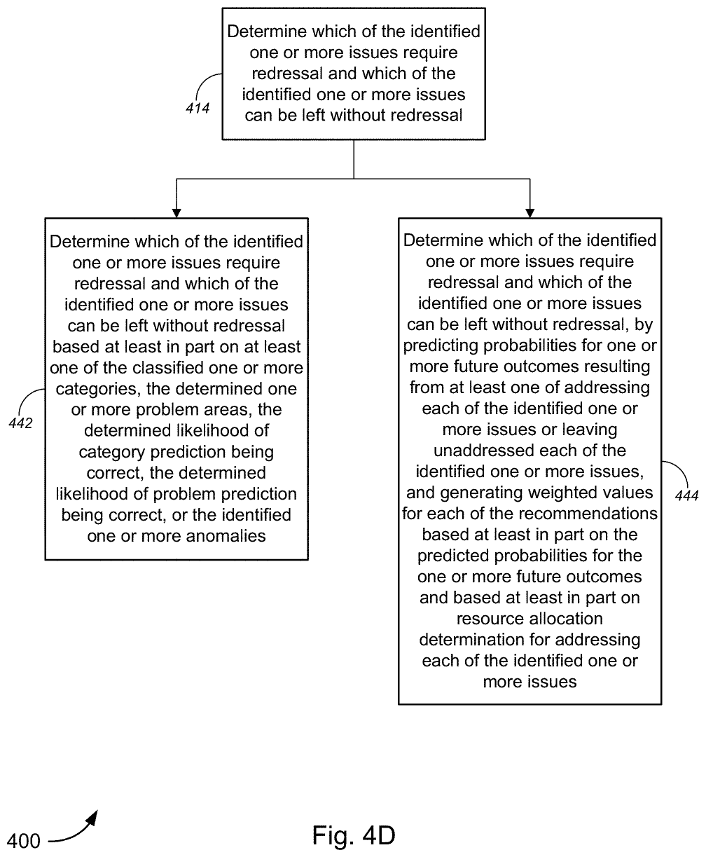

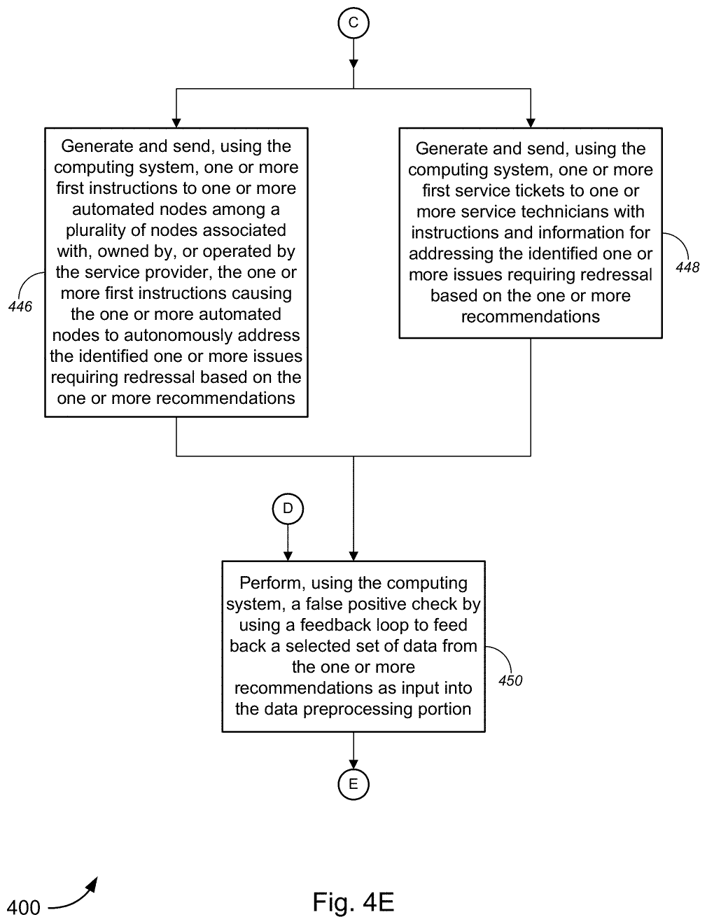

FIGS. 4A-4E (collectively, “FIG. 4”) are flow diagrams illustrating a method 400 for implementing pattern identification for incident prediction and resolution, in accordance with various embodiments. Method 400 of FIG. 4A continues onto FIG. 4C following the circular marker denoted, “A,” and returns to FIG. 4A following the circular marker denoted, “B.” Method 400 of FIG. 4A continues onto FIG. 4E either following the circular marker denoted, “C,” or following the circular marker denoted, “D,” and returns to FIG. 4A following the circular marker denoted, “E.”

While the techniques and procedures are depicted and/or described in a certain order for purposes of illustration, it should be appreciated that certain procedures may be reordered and/or omitted within the scope of various embodiments. Moreover, while the method 400 illustrated by FIG. 4 can be implemented by or with (and, in some cases, are described below with respect to) the systems, examples, or embodiments 100, 200, 300, 300′, and 300″ of FIGS. 1, 2, 3A, 3B-3M, and 3N-3Y, respectively (or components thereof), such methods may also be implemented using any suitable hardware (or software) implementation. Similarly, while each of the systems, examples, or embodiments 100, 200, 300, 300′, and 300″ of FIGS. 1, 2, 3A, 3B-3M, and 3N-3Y, respectively (or components thereof), can operate according to the method 400 illustrated by FIG. 4 (e.g., by executing instructions embodied on a computer readable medium), the systems, examples, or embodiments 100, 200, 300, 300′, and 300″ of FIGS. 1, 2, 3A, 3B-3M, and 3N-3Y can each also operate according to other modes of operation and/or perform other suitable procedures.

In the non-limiting embodiment of FIG. 4A, method 400, at block 402, may comprise receiving, using a computing system, a first set of data associated with a service provided by a service provider, wherein the first set of data comprises current data associated with the service and historical data associated with the service. In some embodiments, the computing system may include, without limitation, at least one of a service management computing system, an artificial intelligence (“AI”) system, a machine learning system, a deep learning system, a server computer over a network, a cloud computing system, or a distributed computing system, and/or the like. In some instances, the first set of data including service management input data including, but not limited to, at least one of service management input data, service incident data, warning data, event log data, error data, alert data, human resources input data, or service team input data, and/or the like.

At block 404, method 400 may comprise performing data preprocessing. Method 400 may further comprise, at block 406, analyzing, using the computing system, the historical data to generate baselining data associated with the service based on a prediction model. Method 400 may further comprise updating, using the computing system, the prediction model to improve baselining data generation (block 408). Method 400, at block 410, may comprise analyzing, using the computing system, the current data compared with the baselining data to identify one or more issues associated with the service. At block 412, method 400 may comprise analyzing, using the computing system, the identified one or more issues to perform one or more predictions. Alternatively, or additionally, at block 414, method 400 may comprise analyzing, using the computing system, the identified one or more issues to determine which of the identified one or more issues require redressal and which of the identified one or more issues can be left without redressal, based on the one or more predictions. Method 400 either may continue onto the process at block 416 or may continue onto the process at block 440 in FIG. 4C following the circular marker denoted, “A.”

Method 400 may further comprise, at block 416, generating and sending, using the computing system, one or more recommendations regarding which of the identified one or more issues require redressal and which of the identified one or more issues can be left without redressal.

Method 400 either may return to the process at block 402, may continue onto the process at block 446 or block 448 in FIG. 4E following the circular marker denoted, “C,” or may continue onto the process at block 450 in FIG. 4E following the circular marker denoted, “D.”

With reference to FIG. 4B, performing data preprocessing (at block 404) may comprise performing, using the computing system, data classification on the first set of data, by providing data labelling to the first set of data based at least in part on type of data (block 418); performing, using the computing system, data cleaning on the first set of data based at least in part on the data classification to produce second set of data, the second set of data comprising non-redundant, non-blank, non-formatted data without punctuations, whitespaces, stop words, and non-conforming data structures (block 420); performing, using the computing system, data distribution on the second set of data to produce balanced data based at least in part on data labelling and data classification (block 422); performing, using the computing system, feature extraction on the balanced data to identify at least one of key features or attributes of data among the balanced data (block 424); and performing, using the computing system, vectorization on the at least one of the key features or the attributes of data among the balanced data, by assigning probabilities to similar features to conform more closely to the data labelling (block 426).

According to some embodiments, generating baselining data associated with the service (at block 406) may comprise generating baselining data based at least in part on the vectorization performed on the at least one of the key features or the attributes of data among the balanced data (block 428).

Referring to FIG. 4C, performing the one or more predictions (at block 412) may include, without limitation, at least one of: performing, using the computing system, category prediction to classify the identified one or more issues into one or more categories (block 430); performing, using the computing system, problem prediction to identify one or more problem areas for each of the identified one or more issues (block 432); calculating, using the computing system, prediction likelihood to determine at least one of likelihood of category prediction being correct or likelihood of problem prediction being correct (block 434); or performing, using the computing system, anomaly detection and management to identify one or more anomalies among at least one of the identified one or more issues, the historical data associated with the service, or the current data associated with the service (block 436); and/or the like. In some instances, performing problem prediction (at block 432) may comprise performing active prediction to identify at least one of one or more future incidents, one or more future problems, a relation matrix among at least one of the one or more future problems or the identified one or more problem areas, one or more potential incident trends, one or more potential problem trends, or one or more visualization data adapted to service management, and/or the like (block 438).

At block 440 (following the circular marker denoted, “A,” from FIG. 4A), method 400 may comprise generating, using the computing system, at least one of a potential problem signature or one or more crisis patterns, based at least in part on the active prediction and based at least in part on automated task creation and resolution. Method 400 may continue onto the process at block 416 in FIG. 4A following the circular marker denoted, “B.”

Turning to FIG. 4D, determining which of the identified one or more issues require redressal and which of the identified one or more issues can be left without redressal (at block 414) may comprise determining which of the identified one or more issues require redressal and which of the identified one or more issues can be left without redressal based at least in part on at least one of the classified one or more categories, the determined one or more problem areas, the determined likelihood of category prediction being correct, the determined likelihood of problem prediction being correct, or the identified one or more anomalies, and/or the like (block 442). Alternatively, or additionally, determining which of the identified one or more issues require redressal and which of the identified one or more issues can be left without redressal (at block 414) may comprise determining which of the identified one or more issues require redressal and which of the identified one or more issues can be left without redressal, by predicting probabilities for one or more future outcomes resulting from at least one of addressing each of the identified one or more issues or leaving unaddressed each of the identified one or more issues, and generating weighted values for each of the recommendations based at least in part on the predicted probabilities for the one or more future outcomes and based at least in part on resource allocation determination for addressing each of the identified one or more issues (block 444).

In FIG. 4E (following the circular marker denoted, “C”), method 400 may comprise at least one of: generating and sending, using the computing system, one or more first instructions to one or more automated nodes among a plurality of nodes associated with, owned by, or operated by the service provider, the one or more first instructions causing the one or more automated nodes to autonomously address the identified one or more issues requiring redressal based on the one or more recommendations (block 446); or generating and sending, using the computing system, one or more first service tickets to one or more service technicians with instructions and information for addressing the identified one or more issues requiring redressal based on the one or more recommendations (block 448).

In some embodiments, analyzing the historical data and analyzing the current data may be part of a data preprocessing portion. At block 450 (either continuing from block 446 or block 448, or following the circular marker denoted, “D,” from FIG. 4A), method 400 may comprise performing, using the computing system, a false positive check by using a feedback loop to feed back a selected set of data from the one or more recommendations as input into the data preprocessing portion. In some instances, generating the baselining data and identifying the one or more issues may be performed based on the selected set of data. According to some embodiments, the selected set of data may include, without limitation, a random recommendation among a first predetermined number of recommendations. In some cases, the random recommendation may be based on a random pattern that is sequentially changed to ensure that the selection is not based on any set pattern. In some instances, a prediction generation logic used to perform problem prediction may be validated against control data for every second predetermined number of recommendations.

Method 400 may continue onto the process at block 404 in FIG. 4A following the circular marker denoted, “E.”

Exemplary System and Hardware Implementation

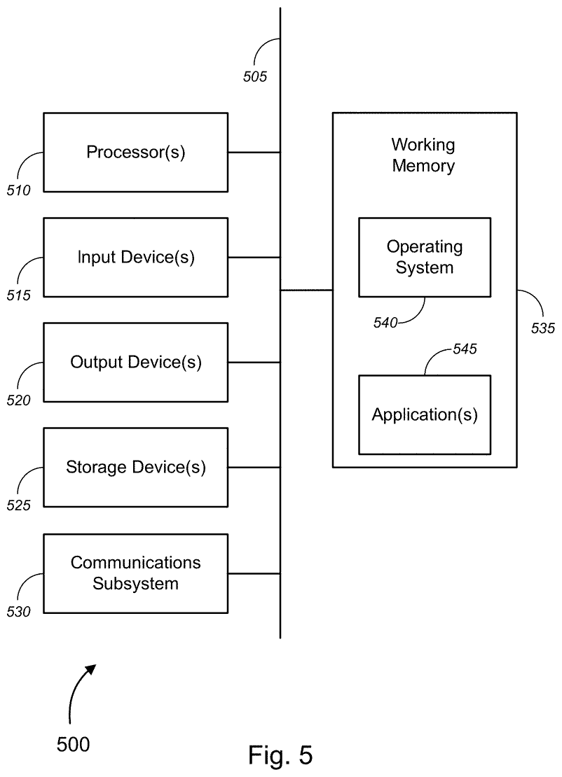

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., computing system 105, artificial intelligence (“AI”) system 115, service nodes 130a-130n, data sources 135a-135n, and user devices 145a-145n, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., computing system 105, AI system 115, service nodes 130a-130n, data sources 135a-135n, and user devices 145a-145n, etc.), described above with respect to FIGS. 1-4—is shown comprising hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further comprise a working memory 535, which can include a RAM or ROM device, as described above.

The computer or hardware system 500 also may comprise software elements, shown as being currently located within the working memory 535, including an operating system 540, device drivers, executable libraries, and/or other code, such as one or more application programs 545, which may comprise computer programs provided by various embodiments (including, without limitation, hypervisors, VMs, and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that comprise the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

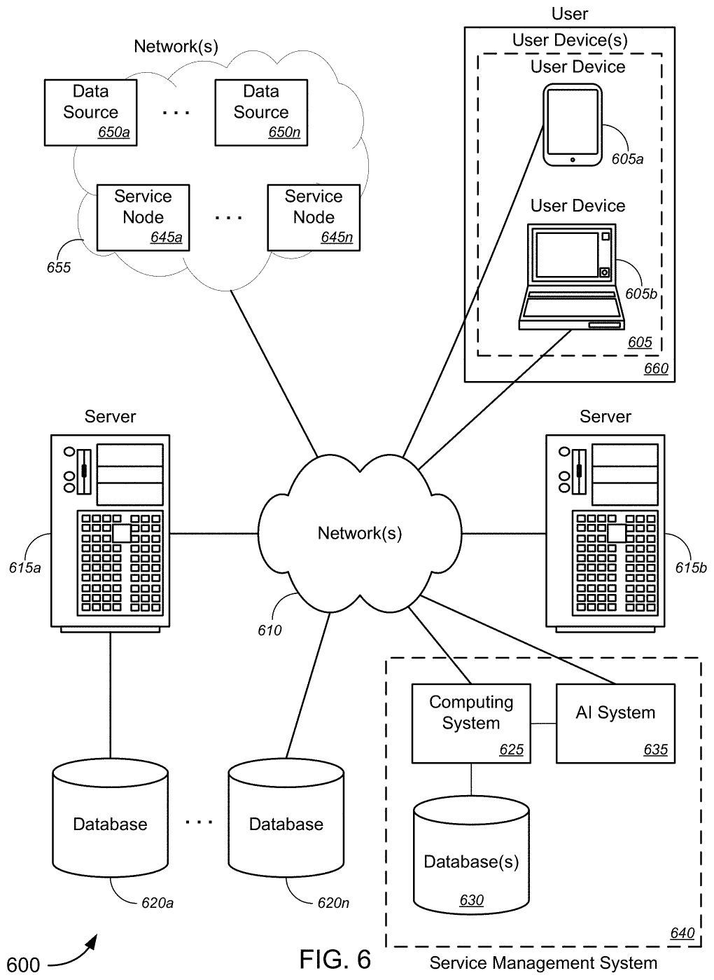

As noted above, a set of embodiments comprises methods and systems for implementing incident prediction and resolution, and, more particularly, to methods, systems, and apparatuses for implementing pattern identification for incident prediction and resolution. FIG. 6 illustrates a schematic diagram of a system 600 that can be used in accordance with one set of embodiments. The system 600 can include one or more user computers, user devices, or customer devices 605. A user computer, user device, or customer device 605 can be a general purpose personal computer (including, merely by way of example, desktop computers, tablet computers, laptop computers, handheld computers, and the like, running any appropriate operating system, several of which are available from vendors such as Apple, Microsoft Corp., and the like), cloud computing devices, a server(s), and/or a workstation computer(s) running any of a variety of commercially-available UNIX™ or UNIX-like operating systems. A user computer, user device, or customer device 605 can also have any of a variety of applications, including one or more applications configured to perform methods provided by various embodiments (as described above, for example), as well as one or more office applications, database client and/or server applications, and/or web browser applications. Alternatively, a user computer, user device, or customer device 605 can be any other electronic device, such as a thin-client computer, Internet-enabled mobile telephone, and/or personal digital assistant, capable of communicating via a network (e.g., the network(s) 610 described below) and/or of displaying and navigating web pages or other types of electronic documents. Although the exemplary system 600 is shown with two user computers, user devices, or customer devices 605, any number of user computers, user devices, or customer devices can be supported.

Certain embodiments operate in a networked environment, which can include a network(s) 610. The network(s) 610 can be any type of network familiar to those skilled in the art that can support data communications using any of a variety of commercially-available (and/or free or proprietary) protocols, including, without limitation, TCP/IP, SNA™ IPX™ AppleTalk™, and the like. Merely by way of example, the network(s) 610 (similar to network(s) 125 and 140 of FIG. 1, or the like) can each include a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 615. Each of the server computers 615 may be configured with an operating system, including, without limitation, any of those discussed above, as well as any commercially (or freely) available server operating systems. Each of the servers 615 may also be running one or more applications, which can be configured to provide services to one or more clients 605 and/or other servers 615.

Merely by way of example, one of the servers 615 might be a data server, a web server, a cloud computing device(s), or the like, as described above. The data server might include (or be in communication with) a web server, which can be used, merely by way of example, to process requests for web pages or other electronic documents from user computers 605. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 605 to perform methods of the invention.

The server computers 615, in some embodiments, might include one or more application servers, which can be configured with one or more applications accessible by a client running on one or more of the client computers 605 and/or other servers 615. Merely by way of example, the server(s) 615 can be one or more general purpose computers capable of executing programs or scripts in response to the user computers 605 and/or other servers 615, including, without limitation, web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™ IBM™, and the like, which can process requests from clients (including, depending on the configuration, dedicated database clients, API clients, web browsers, etc.) running on a user computer, user device, or customer device 605 and/or another server 615. In some embodiments, an application server can perform one or more of the processes for implementing incident prediction and resolution, and, more particularly, to methods, systems, and apparatuses for implementing pattern identification for incident prediction and resolution, as described in detail above. Data provided by an application server may be formatted as one or more web pages (comprising HTML, JavaScript, etc., for example) and/or may be forwarded to a user computer 605 via a web server (as described above, for example). Similarly, a web server might receive web page requests and/or input data from a user computer 605 and/or forward the web page requests and/or input data to an application server. In some cases, a web server may be integrated with an application server.

In accordance with further embodiments, one or more servers 615 can function as a file server and/or can include one or more of the files (e.g., application code, data files, etc.) necessary to implement various disclosed methods, incorporated by an application running on a user computer 605 and/or another server 615. Alternatively, as those skilled in the art will appreciate, a file server can include all necessary files, allowing such an application to be invoked remotely by a user computer, user device, or customer device 605 and/or server 615.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 620a-620n (collectively, “databases 620”). The location of each of the databases 620 is discretionary: merely by way of example, a database 620a might reside on a storage medium local to (and/or resident in) a server 615a (and/or a user computer, user device, or customer device 605). Alternatively, a database 620n can be remote from any or all of the computers 605, 615, so long as it can be in communication (e.g., via the network 610) with one or more of these. In a particular set of embodiments, a database 620 can reside in a storage-area network (“SAN”) familiar to those skilled in the art. (Likewise, any necessary files for performing the functions attributed to the computers 605, 615 can be stored locally on the respective computer and/or remotely, as appropriate.) In one set of embodiments, the database 620 can be a relational database, such as an Oracle database, that is adapted to store, update, and retrieve data in response to SQL-formatted commands. The database might be controlled and/or maintained by a database server, as described above, for example.

According to some embodiments, system 600 may further comprise a computing system 625 and corresponding database(s) 630 (similar to computing system 105 and corresponding database(s) 110 of FIG. 1, or the like), as well as an artificial intelligence (“AI”) system 635 (similar to AI system 115 of FIG. 1, or the like), each of which may be part of a service management system 640 (similar to service management system 120 of FIG. 1, or the like). In some embodiments, the computing system 625 may include, without limitation, at least one of a service management computing system, the AI system, a machine learning system, a deep learning system, a server computer over a network, a cloud computing system, or a distributed computing system, and/or the like. System 600 may further comprise one or more service nodes 645a-645n (collectively, “service nodes 645” or “nodes 645” or the like; similar to service nodes 130a-130b of FIG. 1, or the like), one or more data sources 650a-650n (collectively, “data sources 650” or the like; similar to data sources 135a-135n of FIG. 1, or the like), and one or more networks 655 (similar to network(s) 125 and/or 140 of FIG. 1, or the like). The one or more user devices 605a and 605b (similar to user devices 145a-145n of FIG. 1, or the like) may be associated with a user 660 (similar to users 150a-150n of FIG. 1, or the like), which may include, one of a customer, a service agent, a service technician, or a service management agent, or the like. According to some embodiments, the one or more service nodes 645 may include, without limitation, nodes, devices, machines, or systems, and/or the like, that may be used to perform one or more services provided by a service provider to customers. In some embodiments, the one or more data sources 650 may include, but are not limited to, at least one of one or more service management data sources, one or more service incident data sources, one or more warning data sources, one or more event logs, one or more error data sources, one or more alert data sources, one or more human resources data sources, or one or more service team data sources, and/or the like.

In operation, computing system 625 and/or AI system 635 (collectively, “computing system” or the like) may receive a first set of data associated with a service provided by a service provider. In some cases, the first set of data may include, but is not limited to, current data associated with the service and historical data associated with the service, and/or the like. The computing system may analyze the historical data to generate baselining data associated with the service based on a prediction model. The computing system may analyze the current data compared with the baselining data to identify one or more issues associated with the service. The computing system may analyze the identified one or more issues to perform one or more predictions and to determine which of the identified one or more issues require redressal and which of the identified one or more issues can be left without redressal (i.e., issues that may be avoided, or the like), based on the one or more predictions. The computing system may generate and send one or more recommendations regarding which of the identified one or more issues require redressal and which of the identified one or more issues can be left without redressal.

In some cases, the first set of data may include service management input data including, but not limited to, at least one of service management input data, service incident data, warning data, event log data, error data, alert data, human resources input data, or service team input data, and/or the like.

According to some embodiments, the computing system may perform data preprocessing, which may include, without limitation: performing data classification on the first set of data, by providing data labelling to the first set of data based at least in part on type of data; performing data cleaning on the first set of data based at least in part on the data classification to produce second set of data, the second set of data including, but not limited to, non-redundant, non-blank, non-formatted data without punctuations, whitespaces, stop words, and non-conforming data structures, or the like; performing data distribution on the second set of data to produce balanced data based at least in part on data labelling and data classification; performing feature extraction on the balanced data to identify at least one of key features or attributes of data among the balanced data; and performing vectorization on the at least one of the key features or the attributes of data among the balanced data, by assigning probabilities to similar features to conform more closely to the data labelling; and/or the like. In some cases, generating baselining data may be based at least in part on the vectorization performed on the at least one of the key features or the attributes of data among the balanced data, or the like. In some instances, the prediction model may be an AI model, and the computing system may update the prediction model to improve baselining data generation, based at least in part on the vectorization performed on the at least one of the key features or the attributes of data among the balanced data.

In some embodiments, the computing system performing the one or more predictions may include, but are not limited to, at least one of: performing category prediction to classify the identified one or more issues into one or more categories; performing problem prediction to identify one or more problem areas for each of the identified one or more issues; calculating prediction likelihood to determine at least one of likelihood of category prediction being correct or likelihood of problem prediction being correct; or performing anomaly detection and management to identify one or more anomalies among at least one of the identified one or more issues, the historical data associated with the service, or the current data associated with the service, and/or the like; and/or the like. In some cases, determining which of the identified one or more issues require redressal and which of the identified one or more issues can be left without redressal may comprise determining which of the identified one or more issues require redressal and which of the identified one or more issues can be left without redressal based at least in part on at least one of the classified one or more categories, the determined one or more problem areas, the determined likelihood of category prediction being correct, the determined likelihood of problem prediction being correct, or the identified one or more anomalies, and/or the like. In some instances, performing problem prediction may comprise performing active prediction to identify at least one of one or more future incidents, one or more future problems, a relation matrix among at least one of the one or more future problems or the identified one or more problem areas, one or more potential incident trends, one or more potential problem trends, or one or more visualization data adapted to service management, and/or the like. In some cases, the computing system may generate at least one of a potential problem signature or one or more crisis patterns, based at least in part on the active prediction and based at least in part on automated task creation and resolution.

According to some embodiments, determining which of the identified one or more issues require redressal and which of the identified one or more issues can be left without redressal may alternatively or additionally comprise determining which of the identified one or more issues require redressal and which of the identified one or more issues can be left without redressal, by predicting probabilities for one or more future outcomes resulting from at least one of addressing each of the identified one or more issues or leaving unaddressed each of the identified one or more issues, and generating weighted values for each of the recommendations based at least in part on the predicted probabilities for the one or more future outcomes and based at least in part on resource allocation determination for addressing each of the identified one or more issues.

In some embodiments, the computing system may further perform at least one of: generating and sending one or more first instructions to one or more automated nodes among a plurality of nodes associated with, owned by, or operated by the service provider, the one or more first instructions causing the one or more automated nodes to autonomously address the identified one or more issues requiring redressal based on the one or more recommendations; or generating and sending one or more first service tickets to one or more service technicians with instructions and information for addressing the identified one or more issues requiring redressal based on the one or more recommendations; and/or the like.

According to some embodiments, analyzing the historical data and analyzing the current data may be part of a data preprocessing portion, and the computing system may perform a false positive check by using a feedback loop to feed back a selected set of data from the one or more recommendations as input into the data preprocessing portion, where generating the baselining data and identifying the one or more issues may be performed based on the selected set of data. In some instances, the selected set of data may comprise a random recommendation among a first predetermined number of recommendations, the random recommendation being based on a random pattern that is sequentially changed to ensure that the selection is not based on any set pattern. In some cases, a prediction generation logic used to perform problem prediction may be validated against control data for every second predetermined number of recommendations.

These and other functions of the system 600 (and its components) are described in greater detail above with respect to FIGS. 1-4.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, using a computing system, a first set of data associated with a service provided by a service provider, wherein the first set of data comprises current data associated with the service and historical data associated with the service;
analyzing, using the computing system, the historical data to generate baselining data associated with the service based on a prediction model;
analyzing, using the computing system, the current data compared with the baselining data to identify one or more issues associated with the service;
analyzing, using the computing system, the identified one or more issues to perform one or more predictions and to determine which of the identified one or more issues require redressal and which of the identified one or more issues can be left without redressal, based on the one or more predictions; and
generating and sending, using the computing system, one or more recommendations regarding which of the identified one or more issues require redressal and which of the identified one or more issues can be left without redressal.

2. The method of claim 1, wherein the computing system comprises at least one of a service management computing system, an artificial intelligence (“AI”) system, a machine learning system, a deep learning system, a server computer over a network, a cloud computing system, or a distributed computing system.

3. The method of claim 1, wherein the first set of data comprises service management input data comprising at least one of service management input data, service incident data, warning data, event log data, error data, alert data, human resources input data, or service team input data.

4. The method of claim 1, further comprising performing data preprocessing comprising:
performing, using the computing system, data classification on the first set of data, by providing data labelling to the first set of data based at least in part on type of data;
performing, using the computing system, data cleaning on the first set of data based at least in part on the data classification to produce second set of data, the second set of data comprising non-redundant, non-blank, non-formatted data without punctuations, whitespaces, stop words, and non-conforming data structures;
performing, using the computing system, data distribution on the second set of data to produce balanced data based at least in part on data labelling and data classification;
performing, using the computing system, feature extraction on the balanced data to identify at least one of key features or attributes of data among the balanced data; and
performing, using the computing system, vectorization on the at least one of the key features or the attributes of data among the balanced data, by assigning probabilities to similar features to conform more closely to the data labelling;
wherein generating baselining data is based at least in part on the vectorization performed on the at least one of the key features or the attributes of data among the balanced data.

5. The method of claim 4, wherein the prediction model is an artificial intelligence (“AI”) model, wherein the method further comprises:
updating, using the computing system, the prediction model to improve baselining data generation, based at least in part on the vectorization performed on the at least one of the key features or the attributes of data among the balanced data.

6. The method of claim 1, wherein performing the one or more predictions comprises at least one of:
performing, using the computing system, category prediction to classify the identified one or more issues into one or more categories;
performing, using the computing system, problem prediction to identify one or more problem areas for each of the identified one or more issues;
calculating, using the computing system, prediction likelihood to determine at least one of likelihood of category prediction being correct or likelihood of problem prediction being correct; or
performing, using the computing system, anomaly detection and management to identify one or more anomalies among at least one of the identified one or more issues, the historical data associated with the service, or the current data associated with the service;
wherein determining which of the identified one or more issues require redressal and which of the identified one or more issues can be left without redressal comprises determining which of the identified one or more issues require redressal and which of the identified one or more issues can be left without redressal based at least in part on at least one of the classified one or more categories, the determined one or more problem areas, the determined likelihood of category prediction being correct, the determined likelihood of problem prediction being correct, or the identified one or more anomalies.

7. The method of claim 6, wherein performing problem prediction comprises performing active prediction to identify at least one of one or more future incidents, one or more future problems, a relation matrix among at least one of the one or more future problems or the identified one or more problem areas, one or more potential incident trends, one or more potential problem trends, or one or more visualization data adapted to service management.

8. The method of claim 7, further comprising:
generating, using the computing system, at least one of a potential problem signature or one or more crisis patterns, based at least in part on the active prediction and based at least in part on automated task creation and resolution.

9. The method of claim 1, wherein determining which of the identified one or more issues require redressal and which of the identified one or more issues can be left without redressal comprises determining which of the identified one or more issues require redressal and which of the identified one or more issues can be left without redressal, by predicting probabilities for one or more future outcomes resulting from at least one of addressing each of the identified one or more issues or leaving unaddressed each of the identified one or more issues, and generating weighted values for each of the recommendations based at least in part on the predicted probabilities for the one or more future outcomes and based at least in part on resource allocation determination for addressing each of the identified one or more issues.

10. The method of claim 1, further comprising at least one of:
generating and sending, using the computing system, one or more first instructions to one or more automated nodes among a plurality of nodes associated with, owned by, or operated by the service provider, the one or more first instructions causing the one or more automated nodes to autonomously address the identified one or more issues requiring redressal based on the one or more recommendations; or
generating and sending, using the computing system, one or more first service tickets to one or more service technicians with instructions and information for addressing the identified one or more issues requiring redressal based on the one or more recommendations.

11. The method of claim 1, wherein analyzing the historical data and analyzing the current data are part of a data preprocessing portion, wherein the method further comprises:
performing, using the computing system, a false positive check by using a feedback loop to feed back a selected set of data from the one or more recommendations as input into the data preprocessing portion, wherein generating the baselining data and identifying the one or more issues are performed based on the selected set of data.

12. The method of claim 11, wherein the selected set of data comprises a random recommendation among a first predetermined number of recommendations, the random recommendation being based on a random pattern that is sequentially changed to ensure that the selection is not based on any set pattern, wherein a prediction generation logic used to perform problem prediction is validated against control data for every second predetermined number of recommendations.

13. A system, comprising:
a computing system, comprising:
at least one first processor; and
a first non-transitory computer readable medium communicatively coupled to the at least one first processor, the first non-transitory computer readable medium having stored thereon computer software comprising a first set of instructions that, when executed by the at least one first processor, causes the computing system to:
receive a first set of data associated with a service provided by a service provider, wherein the first set of data comprises current data associated with the service and historical data associated with the service;
analyze the historical data to generate baselining data associated with the service based on a prediction model;
analyze the current data compared with the baselining data to identify one or more issues associated with the service;
analyze the identified one or more issues to perform one or more predictions and to determine which of the identified one or more issues require redressal and which of the identified one or more issues can be left without redressal, based on the one or more predictions; and
generate and send one or more recommendations regarding which of the identified one or more issues require redressal and which of the identified one or more issues can be left without redressal.

14. The system of claim 13, wherein the computing system comprises at least one of a service management computing system, an artificial intelligence (“AI”) system, a machine learning system, a deep learning system, a server computer over a network, a cloud computing system, or a distributed computing system.

15. The system of claim 13, wherein the first set of data comprises service management input data comprising at least one of service management input data, service incident data, warning data, event log data, error data, alert data, human resources input data, or service team input data.

16. The system of claim 13, wherein the first set of instructions, when executed by the at least one first processor, further causes the computing system to perform data preprocessing comprising:
performing data classification on the first set of data, by providing data labelling to the first set of data based at least in part on type of data;
performing data cleaning on the first set of data based at least in part on the data classification to produce second set of data, the second set of data comprising non-redundant, non-blank, non-formatted data without punctuations, whitespaces, stop words, and non-conforming data structures;
performing data distribution on the second set of data to produce balanced data based at least in part on data labelling and data classification;
performing feature extraction on the balanced data to identify at least one of key features or attributes of data among the balanced data; and
performing vectorization on the at least one of the key features or the attributes of data among the balanced data, by assigning probabilities to similar features to conform more closely to the data labelling;
wherein generating baselining data is based at least in part on the vectorization performed on the at least one of the key features or the attributes of data among the balanced data.

17. The system of claim 16, wherein the prediction model is an artificial intelligence (“AI”) model, wherein the first set of instructions, when executed by the at least one first processor, further causes the computing system to:
update the prediction model to improve baselining data generation, based at least in part on the vectorization performed on the at least one of the key features or the attributes of data among the balanced data.

18. The system of claim 13, wherein determining which of the identified one or more issues require redressal and which of the identified one or more issues can be left without redressal comprises determining which of the identified one or more issues require redressal and which of the identified one or more issues can be left without redressal, by predicting probabilities for one or more future outcomes resulting from at least one of addressing each of the identified one or more issues or leaving unaddressed each of the identified one or more issues, and generating weighted values for each of the recommendations based at least in part on the predicted probabilities for the one or more future outcomes and based at least in part on resource allocation determination for addressing each of the identified one or more issues.

19. The system of claim 13, wherein the first set of instructions, when executed by the at least one first processor, further causes the computing system to perform at least one of:
generating and sending one or more first instructions to one or more automated nodes among a plurality of nodes associated with, owned by, or operated by the service provider, the one or more first instructions causing the one or more automated nodes to autonomously address the identified one or more issues requiring redressal based on the one or more recommendations; or
generating and sending one or more first service tickets to one or more service technicians with instructions and information for addressing the identified one or more issues requiring redressal based on the one or more recommendations.

20. The system of claim 13, wherein analyzing the historical data and analyzing the current data are part of a data preprocessing portion, wherein the first set of instructions, when executed by the at least one first processor, further causes the computing system to:
perform a false positive check by using a feedback loop to feed back a selected set of data from the one or more recommendations as input into the data preprocessing portion, wherein generating the baselining data and identifying the one or more issues are performed based on the selected set of data.
